(19) United States
(12) Patent Application Publication
(10) Pub. No.: US 2026/0142760 A1
(43) Pub. Date: May 21, 2026

(54) TERMINAL APPARATUS, BASE STATION APPARATUS, AND COMMUNICATION METHOD

(71) Applicant: Sharp Kabushiki Kaisha, Sakai City, Osaka (JP)

(72) Inventors: Takahisa FUKUI, Sakai City (JP); Tomoki YOSHIMURA, Sakai City (JP); Toshizo NOGAMI, Sakai City (JP); Shoichi SUZUKI, Sakai City (JP); Daiichiro NAKASHIMA, Sakai City (JP); Wataru OUCHI, Sakai City (JP); Huifa LIN, Sakai City (JP); Ryota MORIMOTO, Sakai City (JP)

(21) Appl. No.: 18/695,374

(22) PCT Filed: Sep. 22, 2022
(86) PCT No.: PCT/JP2022/035433

§ 371 Date: Mar. 26, 2024

(30) Foreign Application Priority Data
Sep. 29, 2021 (JP) 2021-159398

(51) Int. Cl. H04L 5/00

(52) U.S. Cl. CPC H04L 5/0012; H04L 5/0044

(57) ABSTRACT

A terminal apparatus includes a receiver that receives a PDCCH to which DCI scheduling a PUSCH is mapped, and a transmitter that transmits the PUSCH. Frequency hopping for the PUSCH is performed based at least on the DCI, DMRS bundling for the PUSCH is performed, a first upper layer parameter and a second upper layer parameter are configured, in a case that the second upper layer parameter indicates intra-slot frequency hopping, a frequency hopping interval corresponding to the frequency hopping is one slot or less, and in a case that the second upper layer parameter indicates inter-slot frequency hopping, the frequency hopping interval is determined by the first upper layer parameter.

### TECHNICAL FIELD

The present invention relates to a terminal apparatus, a base station apparatus, and a communication method.

This application claims priority to JP 2021-159398 filed on Sep. 29, 2021, the contents of which are incorporated herein by reference.

### BACKGROUND

In the 3^{rd} Generation Partnership Project (3GPP), a radio access method and a radio network for cellular mobile communications (hereinafter also referred to as “Long Term Evolution (LTE)” or “Evolved Universal Terrestrial Radio Access (EUTRA)”) have been studied. In LTE, a base station apparatus is also referred to as an evolved NodeB (eNodeB) and a terminal apparatus is also referred to as a User Equipment (UE). LTE is a cellular communication system in which multiple areas covered by base station apparatuses are arranged in a form of cells. A single base station apparatus may manage multiple serving cells.

The 3GPP has been studying a next generation standard (New Radio or NR) (NPL 1) to make a proposal for International Mobile Telecommunication (IMT)-2020, a standard for a next generation mobile communication system developed by the International Telecommunication Union (ITU). NR is to be satisfy requirements for three scenarios including enhanced Mobile BroadBand (eMBB), massive Machine Type Communication (mMTC), and Ultra Reliable and Low Latency Communication (URLLC) in a single technology framework.

In the 3GPP, extension of services supported by NR has been studied (NPL 2).

### CITATION LIST

### Non Patent Literature

NPL 1:“New SID proposal: Study on New Radio Access Technology”, RP-160671, NTT docomo, 3GPP TSG RAN Meeting #71, Goteborg, Sweden, 7th-10th March, 2016.

NPL 2:“Release 17 package for RAN”, RP-193216, RAN chairman, RANI chairman, RAN2 chairman, RAN3 chairman, 3GPP TSG RAN Meeting #86, Sitges, Spain, 9th-12th December, 2019

### SUMMARY OF INVENTION

### Technical Problem

An aspect of the present invention provides a terminal apparatus that efficiently performs communication, a communication method used for the terminal apparatus, a base station apparatus that efficiently performs communication, and a communication method used for the base station apparatus.

### Solution to Problem

(1) A first aspect of the present invention is a terminal apparatus including a receiver that receives a PDCCH to which DCI scheduling a PUSCH is mapped, and a transmitter that transmits the PUSCH, in which frequency hopping for the PUSCH is performed based at least on the DCI, DMRS bundling for the PUSCH is performed, a first upper layer parameter and a second upper layer parameter are configured, in a case that the second upper layer parameter indicates intra-slot frequency hopping, a frequency hopping interval corresponding to the frequency hopping is one slot or less, and in a case that the second upper layer parameter indicates inter-slot frequency hopping, the frequency hopping interval is determined by the first upper layer parameter.

(2) A second aspect of the present invention is a base station apparatus including a transmitter that transmits a PDCCH to which DCI scheduling a PUSCH is mapped, and a receiver that receives the PUSCH, in which frequency hopping for the PUSCH is performed based at least on the DCI, DMRS bundling for the PUSCH is performed, a first upper layer parameter and a second upper layer parameter are configured, in a case that the second upper layer parameter indicates intra-slot frequency hopping, a frequency hopping interval corresponding to the frequency hopping is one slot or less, and in a case that the second upper layer parameter indicates inter-slot frequency hopping, the frequency hopping interval is determined by the first upper layer parameter.

(3) A third aspect of the present invention is a communication method used in a terminal apparatus, the communication method including the steps of receiving a PDCCH to which DCI scheduling a PUSCH is mapped, and transmitting the PUSCH, in which frequency hopping for the PUSCH is performed based at least on the DCI, DMRS bundling for the PUSCH is performed, a first upper layer parameter and a second upper layer parameter are configured, in a case that the second upper layer parameter indicates intra-slot frequency hopping, a frequency hopping interval corresponding to the frequency hopping is one slot or less, and in a case that the second upper layer parameter indicates inter-slot frequency hopping, the frequency hopping interval is determined by the first upper layer parameter.

(4) A fourth aspect of the present invention is a communication method used in a base station apparatus, the communication method including the steps of transmitting a PDCCH to which DCI scheduling a PUSCH is mapped, and receiving the PUSCH, in which frequency hopping for the PUSCH is performed based at least on the DCI, DMRS bundling for the PUSCH is performed, a first upper layer parameter and a second upper layer parameter are configured, in a case that the second upper layer parameter indicates intra-slot frequency hopping, a frequency hopping interval corresponding to the frequency hopping is one slot or less, and in a case that the second upper layer parameter indicates inter-slot frequency hopping, the frequency hopping interval is determined by the first upper layer parameter.

### Advantageous Effects of Invention

According to an aspect of the present invention, the terminal apparatus can efficiently perform communication. The base station apparatus can efficiently perform communication.

### BRIEF DESCRIPTION OF DRAWINGS

FIG. 1 is a conceptual diagram of a radio communication system according to an aspect of the present embodiment.

FIG. 2 is an example illustrating a relationship between the subcarrier spacing configuration μ, the number of OFDM symbols per slot N^{slot}_{symb}, and a cyclic Prefix (CP) configuration according to an aspect of the present embodiment.

FIG. 3 is a diagram illustrating an example of a configuration method of a resource grid according to an aspect of the present embodiment.

FIG. 4 is a diagram illustrating a configuration example of a resource grid 3001 according to an aspect of the present embodiment.

FIG. 5 is a schematic block diagram illustrating a configuration example of a base station apparatus 3 according to an aspect of the present embodiment.

FIG. 6 is a schematic block diagram illustrating a configuration example of a terminal apparatus 1 according to an aspect of the present embodiment.

FIG. 7 is a diagram illustrating a configuration example of an SS/PBCH block according to an aspect of the present embodiment.

FIG. 8 is a diagram illustrating an example of monitoring occasions for search space sets according to an aspect of the present embodiment.

FIG. 9 is a diagram illustrating an example of a configured time domain window and an actual time domain window according to an aspect of the present embodiment.

### DESCRRIPTION OF EMBODIMENTS

An embodiment of the present invention will be described below.

floor(C) may be a floor function for a real number C. For example, floor(C) may be a function that outputs a maximum integer in a range of not exceeding the real number C. ceil(D) may be a ceiling function for a real number D. For example, ceil(D) may be a function that outputs a minimum integer in a range of not falling below the real number D. mod(E, F) may be a function that outputs a remainder obtained by dividing E by F. mod(E, F) may be a function that outputs a value corresponding to the remainder obtained by dividing E by F. exp(G)=e\hat{ }G. Here, e is a Napier's constant. H\hat{ }I represents H to the power of I. max(J, K) is a function that outputs a maximum value out of J and K. Here, in a case that J and K are equal, max(J, K) is a function that outputs J or K. min(L, M) is a function that outputs a maximum value out of L and M. Here, in a case that L and M are equal, min(L, M) is a function that outputs L or M. round(N) is a function that outputs an integer value of a value closest to N. “·” represents multiplication.

In the radio communication system according to an aspect of the present embodiment, at least Orthogonal Frequency Division Multiplex (OFDM) is used. The OFDM symbol is a time domain unit of the OFDM. The OFDM symbol includes at least one or multiple subcarriers. The OFDM symbol is converted into a time-continuous signal in baseband signal generation. In a downlink, at least Cyclic Prefix—Orthogonal Frequency Division Multiplex (CP-OFDM) is used. In an uplink, either CP-OFDM or Discrete FourierTransform—spread—Orthogonal Frequency Division Multiplex (DFT-s-OFDM) is used. DFT-s-OFDM may be given by applying Transform precoding to the CP-OFDM.

The OFDM symbol may be a term including a CP added to the OFDM symbol. That is, a certain OFDM symbol may include the certain OFDM symbol and the CP added to the certain OFDM symbol.

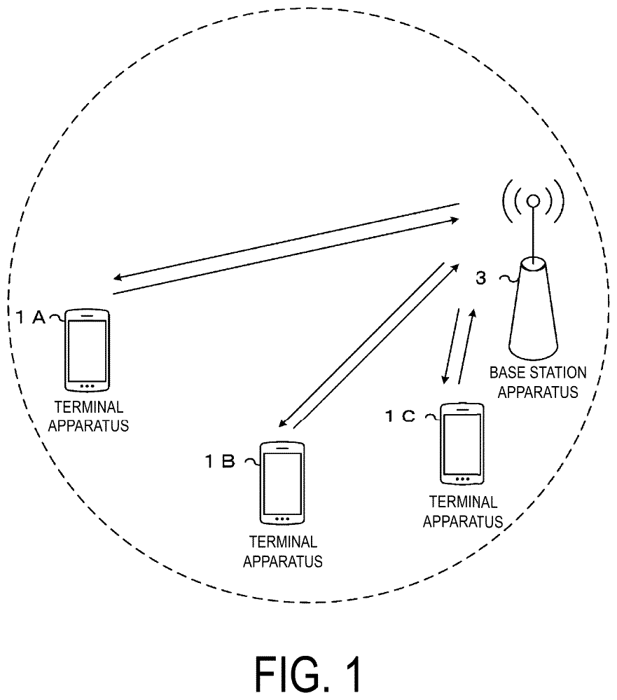

FIG. 1 is a conceptual diagram of a radio communication system according to an aspect of the present embodiment. In FIG. 1, the radio communication system includes at least terminal apparatuses 1A to 1C and a base station apparatus 3 (Base station #3 (BS #3)). Hereinafter, the terminal apparatuses 1A to IC are also referred to as a terminal apparatus 1 (UserEquipment #1 (UE #1)).

The base station apparatus 3 may include one or multiple transmission apparatuses (or transmission points, transmission and/or reception apparatuses, transmission and/or reception points). In a case that the base station apparatus 3 includes multiple transmission apparatuses, the multiple transmission apparatuses may be arranged at different positions.

The base station apparatus 3 may provide one or multiple serving cells. Each serving cell may be defined as a set of resources used for radio communication. The serving cell is also referred to as a cell.

The serving cell may include one or both of one downlink component carrier (downlink carrier) and one uplink component carrier (uplink carrier). The serving cell may include either or both of two or more downlink component carriers, and/or two or more uplink component carriers. The downlink component carrier and the uplink component carrier are also collectively referred to as a component carrier (carrier).

For example, for each component carrier, one resource grid may be given. For each set of one component carrier and a certain subcarrier spacing configuration u, one resource grid may be given. Here, the subcarrier spacing configuration μ is also referred to as numerology. For example, for a set of a certain antenna port p, a certain subcarrier spacing configuration μ, and a certain transmission direction x, one resource grid may be given.

The resource grid includes N^{size, μ}_{grid, x}N^{RB}_{sc} subcarriers. Here, the resource grid starts from a common resource block N^{start, μ}_{grid, x}. The common resource block N^{start, μ}_{grid, x} is also referred to as a reference point of the resource grid.

The resource grid includes N^{subframe, μ}_{symb} OFDM symbols.

The subscript x added to the parameter associated with the resource grid indicates the transmission direction. For example, the subscript x may be used to indicate either of a downlink or an uplink.

N^{size, μ}_{grid, x} is an offset configuration indicated by a parameter provided by the RRC layer (e.g., parameter CarrierBandwidth). N^{start, μ}_{grid, x} is a band configuration indicated by a parameter provided by the RRC layer (e.g., parameter, OffsetToCarrier). The offset configuration and the band configuration are configurations used for configuring an SCS-specific carrier.

The SubCarrier Spacing (SCS) Δf for a certain subcarrier spacing configuration μ may be Δf=2^{μ}*15 kHz. Here, the subcarrier spacing configuration μ may indicate one of 0, 1, 2, 3, or 4.

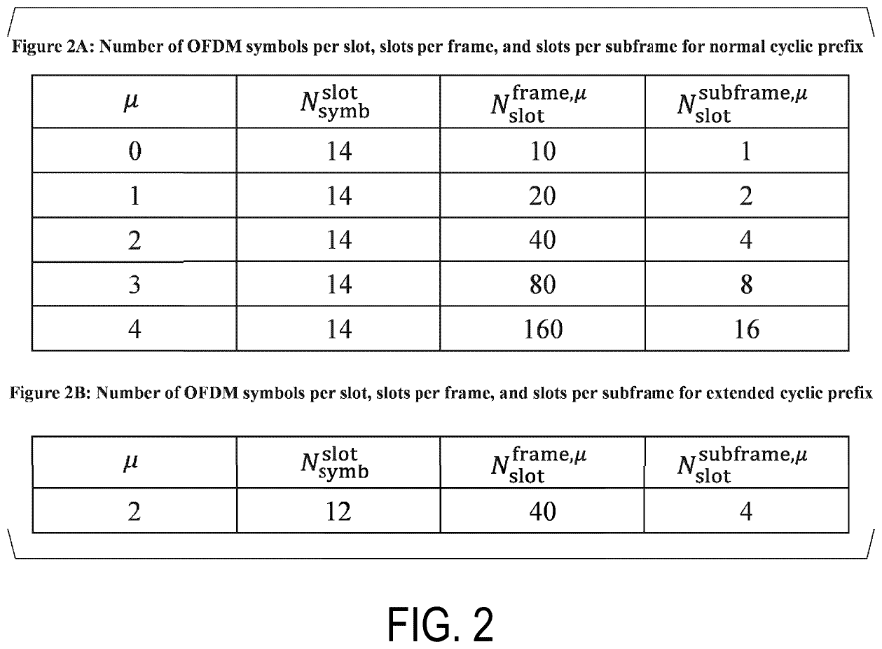

FIG. 2 is an example illustrating a relationship between the subcarrier spacing configuration μ, the number of OFDM symbols per slot N^{slot}_{symb}, and a cyclic Prefix (CP) configuration according to an aspect of the present embodiment. In FIG. 2A, for example, in a case that the subcarrier spacing configuration μ is two and the CP configuration is a normal cyclic prefix (normal CP), N^{slot}_{symb}=14, N^{frame, μ}ₛₗₒₜ=40, and N^{subframe, μ}ₛₗₒₜ=4. In FIG. 2B, for example, in a case that the subcarrier spacing configuration μ is two and the CP configuration is an extended cyclic prefix (extended CP), N^{slot}_{symb}=12, N^{frame, μ}ₛₗₒₜ=40, and N^{subframe, μ}ₛₗₒₜ=4.

The time unit T_{c} may be used to represent the length of the time domain. The time unit T. is T_{c}=1/(Δfₘₐₓ·N_{f}). Δfₘₐₓ=480 kHz. Nᵣ=4096. A constant κ is κ=Δfₘₐₓ·N_{f}/(Δf_{ref}N_{f, ref})=64. Δf_{ref} is 15 kHz. N_{f, ref} is 2048.

Transmission of a signal in the downlink and/or transmission of a signal in the uplink may be organized into a radio frame (system frame, frame) having the length T_{f}. T_{f}=(ΔfₘₐₓN_{f}/100)·Tₛ=10 ms. The radio frame includes 10 subframes. The length T_{sf} of the subframe is (ΔfₘₐₓN_{f}/1000)·Tₛ=1 ms. The number of OFDM symbols per subframe is N^{subframe, μ}_{symb}=N^{slot}_{symb}N^{subframe, μ}ₛₗₒₜ.

The OFDM symbol is a time domain unit of one communication scheme. For example, the OFDM symbol may be a time domain unit of CP-OFDM. The OFDM symbol may be a time domain unit of DFT-s-OFDM.

The slot may include multiple OFDM symbols. For example, N^{slot}_{symb} continuous OFDM symbols may constitute one slot. For example, in normal CP configuration, N^{slot}_{symb} may be 14. In extended CP configuration, N^{slot}_{symb} may be 12.

For a certain subcarrier spacing configuration μ, the number and indices of slots included in the subframe may be given. For example, slot indices n^{μ}ₛ may be given in ascending order in the subframe with integer values within a range of 0 to N^{subframe, μ}ₛₗₒₜ−1. For the subcarrier spacing configuration μ, the number and indices of slots included in the radio frame may be given. Slot indices n^{μ}_{s, f} may be given in ascending order in the radio frame with integer values within a range of 0 to N^{frame, μ}ₛₗₒₜ−1.

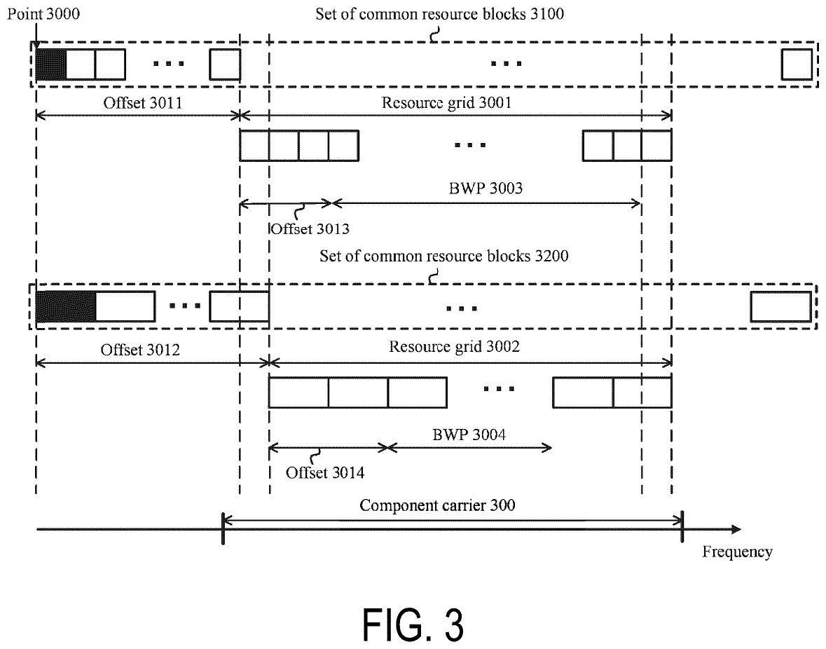

FIG. 3 is a diagram illustrating an example of a configuration method of the resource grid according to an aspect of the present embodiment. The horizontal axis of FIG. 3 represents a frequency domain. FIG. 3 illustrates a configuration example of a resource grid of a subcarrier spacing μ₁ in a component carrier 300, and a configuration example of a resource grid of a subcarrier spacing μ₂ in the certain component carrier. As described above, for a certain component carrier, one or multiple subcarrier spacings may be configured. In FIG. 3, it is assumed that μ₁=μ₂−1, but various aspects of the present embodiment are not limited to the condition of μ₁=μ₂−1.

The component carrier 300 is a band having a predetermined width in the frequency domain.

A Point 3000 is an identifier for identifying a certain subcarrier. The point 3000 is also referred to as a point A. A Common resource block (CRB) set 3100 is a set of common resource blocks for the subcarrier spacing configuration un.

In the common resource block set 3100, a common resource block (solid black block in the common resource block set 3100 in FIG. 3) including the point 3000 is also referred to as a reference point of the common resource block set 3100. The reference point of the common resource block set 3100 may be a common resource block having an index of 0 in the common resource block set 3100.

An offset 3011 is an offset from the reference point of the common resource block set 3100 to a reference point of a resource grid 3001. The offset 3011 is represented by the number of common resource blocks for the subcarrier spacing configuration μ₁. The resource grid 3001 includes N^{size, μ}_{grid1, x} common resource blocks starting from the reference point of the resource grid 3001.

An offset 3013 is an offset from the reference point of the resource grid 3001 to a reference point (N^{start, μ}_{BWP, i1}) of a Band Width Part (BWP) 3003 having an index of i2.

A common resource block set 3200 is a set of common resource blocks for the subcarrier spacing configuration μ₂.

In the common resource block set 3200, a common resource block (solid black block in the common resource block set 3200 in FIG. 3) including the point 3000 is also referred to as a reference point of the common resource block set 3200. The reference point of the common resource block set 3200 may be a common resource block having an index of 0 in the common resource block set 3200.

An offset 3012 is an offset from the reference point of the common resource block set 3200 to a reference point of a resource grid 3002. The offset 3012 is represented by the number of common resource blocks for the subcarrier spacing μ₂. The resource grid 3002 includes N^{size, μ}_{grid2, x} common resource blocks starting from the reference point of the resource grid 3002.

An offset 3014 is an offset from the reference point of the resource grid 3002 to a reference point (N^{start, μ}_{BWP, i2}) of a BWP 3004 having an index of i2.

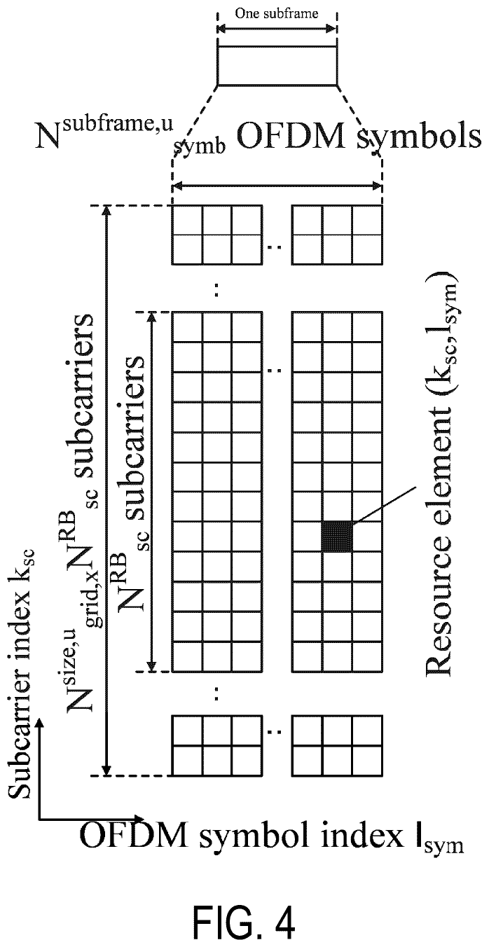

FIG. 4 is a diagram illustrating a configuration example of the resource grid 3001 according to an aspect of the present embodiment. In the resource grid of FIG. 4, the horizontal axis corresponds to an OFDM symbol index l_{sym}, and the vertical axis corresponds to a subcarrier index k_{sc}. The resource grid 3001 includes N^{size, μ}_{grid1, x}N^{RB} _{sc} subcarriers, and N^{subframe, μ}_{symb} OFDM symbols. In the resource grid, a resource identified by the subcarrier index ks and the OFDM symbol index l_{sym} is also referred to as a Resource Element (RE).

The Resource Block (RB) includes N^{RB}_{sc} consecutive subcarriers. The resource block is a general term for a common resource block, a Physical Resource Block (PRB), and a Virtual Resource Block (VRB). Here, N^{RB}_{sc} is 12.

A resource block unit is a set of resources corresponding to one OFDM symbol in one resource block. That is, one resource block unit includes 12 resource elements corresponding to one OFDM symbol in one resource block.

The common resource blocks for a certain subcarrier spacing configuration u are assigned indices in ascending order from 0 in the frequency domain in a certain common resource block set (indexing). The common resource block having an index of 0 for a certain subcarrier spacing configuration μ includes (or collides with, matches) the point 3000. An index n^{μ}_{CRB} of the common resource block for a certain subcarrier spacing configuration μ satisfies a relationship of n^{μ}_{CRB}=ceil(k_{sc}/N^{RB}_{sc}). Here, a subcarrier with k_{sc}=0 is a subcarrier having the same center frequency as the center frequency of a subcarrier corresponding to the point 3000.

Physical resource blocks for a certain subcarrier spacing configuration μ are assigned indices in ascending order from 0 in the frequency domain in a certain BWP. An index n^{μ}_{PRB} of the physical resource block for a certain subcarrier spacing configuration μ satisfies a relationship of n^{μ}_{CRB}=n^{μ}_{PRB}+N^{start, μ}_{BWP, i}. Here, N^{start, μ}_{BWP, i} indicates a reference point of the BWP having an index of i.

The BWP is defined as a subset of common resource blocks included in the resource grid. The BWP includes N^{size, μ}_{BWP, i} common resource blocks starting from the reference point N^{start, μ}_{BWP, i} of the BWP. The BWP configured for the downlink carrier is also referred to as a downlink BWP. The BWP configured for the uplink component carrier is also referred to as an uplink BWP.

An antenna port is defined such that the channel over which a symbol on the antenna port is conveyed can be inferred from the channel over which another symbol on the same antenna port is conveyed. For example, the channel may correspond to a physical channel. The symbol may correspond to an OFDM symbol. The symbol may also correspond to the resource block unit. The symbol may correspond to the resource element.

The fact that a large scale property of a channel over which a symbol on one antenna port is conveyed can be inferred from a channel over which a symbol on another antenna port is conveyed is referred to as the two antenna ports are Quasi Co-Located (QCL). Here, the large scale property may include at least long term performance of a channel. The large scale property may include at least a part or all of delay spread, Doppler spread, Doppler shift, an average gain, an average delay, and a beam parameter (spatial Rx parameters). The fact that the first antenna port and the second antenna port are QCL with respect to a beam parameter may mean that a reception beam assumed by a receiver side for the first antenna port and a reception beam assumed by the receiver side for the second antenna port are the same (or the reception beams correspond to each other). The fact that the first antenna port and the second antenna port are QCL with respect to a beam parameter may mean that a transmission beam assumed by a receiver side for the first antenna port and a transmission beam assumed by the receiver side for the second antenna port are the same (or the transmission beams correspond to each other). In a case that the large scale property of a channel over which a symbol on one antenna port is conveyed can be inferred from a channel over which a symbol on another antenna port is conveyed, the terminal apparatus 1 may assume that the two antenna ports are QCL. The fact that two antenna ports are QCL may mean that the two antenna ports are assumed to be QCL.

Carrier aggregation may mean that communication is performed by using multiple serving cells being aggregated. Carrier aggregation may mean that communication is performed by using multiple component carriers being aggregated. Carrier aggregation may mean that communication is performed by using multiple downlink component carriers being aggregated. Carrier aggregation may mean that communication is performed by using multiple uplink component carriers being aggregated.

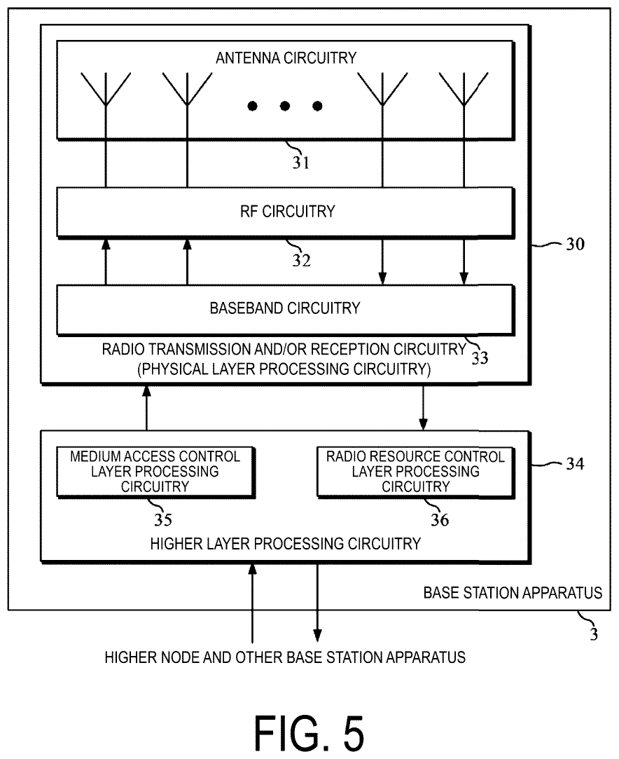

FIG. 5 is a schematic block diagram illustrating a configuration example of the base station apparatus 3 according to an aspect of the present embodiment. As illustrated in FIG. 5, the base station apparatus 3 includes at least a part or all of a radio transmission and/or reception circuitry (physical layer processing circuitry) 30 and/or a Higher layer processing circuitry 34. The radio transmission and/or reception circuitry 30 includes at least a part or all of an antenna circuitry 31, a Radio Frequency (RF) circuitry 32, and a baseband circuitry 33. The higher layer processing circuitry 34 includes at least a part or all of a medium access control layer processing circuitry 35 and a Radio Resource Control (RRC) layer processing circuitry 36.

The radio transmission and/or reception circuitry 30 includes at least a part or all of a radio transmission circuitry 30a and a radio reception circuitry 30b. Here, apparatus configurations of the baseband circuitry included in the radio transmission circuitry 30a and the baseband circuitry included in the radio reception circuitry 30b may be the same or different from each other. Apparatus configurations of the RF circuitry included in the radio transmission circuitry 30a and the RF circuitry included in the radio reception circuitry 30b may be the same or different from each other. Apparatus configurations of the antenna circuitry included in the radio transmission circuitry 30a and the antenna circuitry included in the radio reception circuitry 30b may be the same or different from each other.

For example, the radio transmission circuitry 30a may generate and transmit a baseband signal of the PDSCH. For example, the radio transmission circuitry 30a may generate and transmit a baseband signal of the PDCCH. For example, the radio transmission circuitry 30a may generate and transmit a baseband signal of the PBCH. For example, the radio transmission circuitry 30a may generate and transmit a baseband signal of a synchronization signal. For example, the radio transmission circuitry 30a may generate and transmit a baseband signal of the PDSCH DMRS. For example, the radio transmission circuitry 30a may generate and transmit a baseband signal of the PDCCH DMRS. For example, the radio transmission circuitry 30a may generate and transmit a baseband signal of the CSI-RS. For example, the radio transmission circuitry 30a may generate and transmit a baseband signal of the DL PTRS.

For example, the radio reception circuitry 30b may receive the PRACH. For example, the radio reception circuitry 30b may receive and demodulate the PUCCH. The radio reception circuitry 30b may receive and demodulate the PUSCH. For example, the radio reception circuitry 30b may receive the PUCCH DMRS. For example, the radio reception circuitry 30b may receive the PUSCH DMRS. For example, the radio reception circuitry 30b may receive the UL PTRS. For example, the radio reception circuitry 30b may receive the SRS.

The higher layer processing circuitry 34 outputs downlink data (a transport block) to the radio transmission and/or reception circuitry 30 (or the radio transmission circuitry 30a). The higher layer processing circuitry 34 performs processing operations of a Medium Access Control (MAC) layer, a Packet Data Convergence Protocol (PDCP) layer, a Radio Link Control (RLC) layer, and an RRC layer.

The medium access control layer processing circuitry 35 included in the higher layer processing circuitry 34 performs processing of the MAC layer.

The radio resource control layer processing circuitry 36 included in the higher layer processing circuitry 34 performs processing of the RRC layer. The radio resource control layer processing circuitry 36 manages various pieces of configuration information/parameters (RRC parameters) of the terminal apparatus 1. The radio resource control layer processing circuitry 36 sets the parameter based on an RRC message received from the terminal apparatus 1.

The radio transmission and/or reception circuitry 30 (or the radio transmission circuitry 30a) performs processing such as modulation and coding. The radio transmission and/or reception circuitry 30 (or the radio transmission circuitry 30a) generates a physical signal through modulation, coding, and baseband signal generation (conversion into the time-continuous signal) on the downlink data, and transmits the physical signal to the terminal apparatus 1. The radio transmission and/or reception circuitry 30 (or the radio transmission circuitry 30a) may map the physical signal to a certain component carrier and transmit the physical signal to the terminal apparatus 1.

The radio transmission and/or reception circuitry 30 (or the radio reception circuitry 30b) performs processing such as demodulation and decoding. The radio transmission and/or reception circuitry 30 (or the radio reception circuitry 30b) separates, demodulates, and decodes the received physical signal, and outputs the decoded information to the higher layer processing circuitry 34. The radio transmission and/or reception circuitry 30 (or the radio reception circuitry 30b) may perform a channel access procedure prior to transmission of the physical signal.

The RF circuitry 32 converts (down converts) a signal received via the antenna circuitry 31 into a baseband signal by means of quadrature demodulation and removes unnecessary frequency components. The RF circuitry 32 outputs a processed analog signal to the baseband circuitry.

The baseband circuitry 33 converts an analog signal input from the RF circuitry 32 into a digital signal. The baseband circuitry 33 removes a portion corresponding to a Cyclic Prefix (CP) from the converted digital signal, performs a Fast Fourier Transform (FFT) on the signal from which the CP has been removed, and extracts a signal in the frequency domain.

The baseband circuitry 33 performs Inverse Fast Fourier Transform (IFFT) on the data to generate an OFDM symbol, adds a CP to the generated OFDM symbol, generates a baseband digital signal, and converts the baseband digital signal into an analog signal. The baseband circuitry 33 outputs the converted analog signal to the RF circuitry 32.

The RF circuitry 32 removes an unnecessary frequency component from the analog signal input from the baseband circuitry 33 by using a low-pass filter, up converts the analog signal into a signal having a carrier frequency, and transmits the signal via the antenna circuitry 31. The RF circuitry 32 may have a function of controlling transmission power. The RF circuitry 32 is also referred to as a transmission power control circuitry.

For the terminal apparatus 1, one or multiple serving cells (or component carriers, downlink component carriers, uplink component carriers) may be configured.

Each of the serving cells configured for the terminal apparatus 1 may be one of a Primary cell (PCell), a Primary SCG cell (PSCell), or a Secondary Cell (SCell).

The PCell is a serving cell included in a Master Cell Group (MCG). The PCell is a cell in which an initial connection establishment procedure or a connection re-establishment procedure is performed (has been performed) by the terminal apparatus 1.

The PSCell is a serving cell included in a Secondary Cell Group (SCG). The PSCell is a serving cell in which random access is performed by the terminal apparatus 1.

The SCell may be included in either of the MCG or the SCG.

A serving cell group (cell group) is a term at least including an MCG and an SCG. The serving cell group may include one or multiple serving cells (or component carriers). One or multiple serving cells (or component carriers) included in the serving cell group may be operated by means of carrier aggregation.

One or multiple downlink BWPs may be configured for each of the serving cells (or downlink component carriers). One or multiple uplink BWPs may be configured for each of the serving cells (or uplink component carriers).

Among one or multiple downlink BWPs configured for the serving cell (or the downlink component carrier), one downlink BWP may be configured as an active downlink BWP (or one downlink BWP may be activated). Among one or multiple uplink BWPs configured for the serving cell (or the uplink component carrier), one uplink BWP may be configured as an active uplink BWP (or one uplink BWP may be activated).

The PDSCH, the PDCCH, and the CSI-RS may be received in the active downlink BWP. The terminal apparatus 1 may attempt to receive the PDSCH, the PDCCH, and the CSI-RS in the active downlink BWP. The PUCCH and the PUSCH may be transmitted in the active uplink BWP. The terminal apparatus 1 may transmit the PUCCH and the PUSCH in the active uplink BWP. The active downlink BWP and the active uplink BWP are also collectively referred to as an active BWP.

The PDSCH, the PDCCH, and the CSI-RS need not be received in downlink BWPs (inactive downlink BWPs) other than the active downlink BWP. The terminal apparatus 1 need not attempt to receive the PDSCH, the PDCCH, and the CSI-RS in downlink BWPs that are not the active downlink BWP. The PUCCH and the PUSCH need not be transmitted in uplink BWPs (inactive uplink BWPs) that are not the active uplink BWP. The terminal apparatus 1 need not transmit the PUCCH and the PUSCH in uplink BWPs that are not the active uplink BWP. The inactive downlink BWP and the inactive uplink BWP are also collectively referred to as an inactive BWP.

Downlink BWP switch is a procedure for deactivating one active downlink BWP of a certain serving cell and activating any one of the inactive downlink BWPs of the certain serving cell. The downlink BWP switch may be controlled by a BWP field included in downlink control information. The downlink BWP switch may be controlled based on a higher layer parameter.

Uplink BWP switch is used for deactivating one active uplink BWP and activating any one of the inactive uplink BWPs that are not the one active uplink BWP. The uplink BWP switch may be controlled by a BWP field included in downlink control information. The uplink BWP switch may be controlled based on a higher layer parameter.

Among one or multiple downlink BWPs configured for the serving cell, two or more downlink BWPs need not be configured for the active downlink BWP. For the serving cell, at certain times, one downlink BWP may be active.

Among one or multiple uplink BWPs configured for the serving cell, two or more uplink BWPs need not be configured for the active uplink BWP. For the serving cell, at certain times, one uplink BWP may be active.

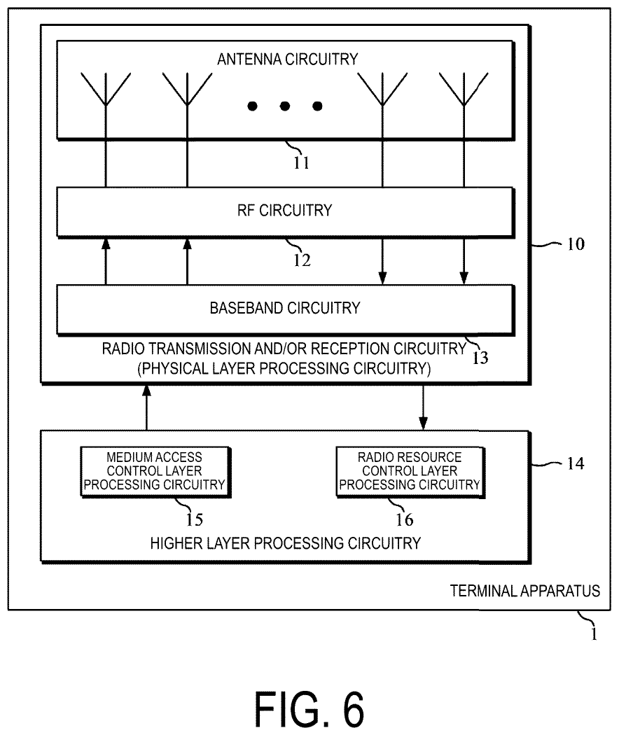

FIG. 6 is a schematic block diagram illustrating a configuration example of the terminal apparatus 1 according to an aspect of the present embodiment. As illustrated in FIG. 6, the terminal apparatus 1 includes at least one or all of a radio transmission and/or reception circuitry (physical layer processing circuitry) 10 and a higher layer processing circuitry 14. The radio transmission and/or reception circuitry 10 includes at least a part or all of an antenna circuitry 11, an RF circuitry 12, and a baseband circuitry 13. The higher layer processing circuitry 14 includes at least a part or all of a medium access control layer processing circuitry 15 and a radio resource control layer processing circuitry 16.

The radio transmission and/or reception circuitry 10 includes at least a part or all of a radio transmission circuitry 10a and a radio reception circuitry 10b. Here, apparatus configurations of the baseband circuitry 13 included in the radio transmission circuitry 10a and the baseband circuitry 13 included in the radio reception circuitry 10b may be the same or different from each other. Apparatus configurations of the RF circuitry 12 included in the radio transmission circuitry 10a and the RF circuitry 12 included in the radio reception circuitry 10b may be the same or different from each other. Apparatus configurations of the antenna circuitry 11 included in the radio transmission circuitry 10a and the antenna circuitry 11 included in the radio reception circuitry 10b may be the same or different from each other.

For example, the radio transmission circuitry 10a may generate and transmit a baseband signal of the PRACH. For example, the radio transmission circuitry 10a may generate and transmit a baseband signal of the PUCCH. The radio transmission circuitry 10a may generate and transmit a baseband signal of the PUSCH. For example, the radio transmission circuitry 10a may generate and transmit a baseband signal of the PUCCH DMRS. For example, the radio transmission circuitry 10a may generate and transmit a baseband signal of the PUSCH DMRS. For example, the radio transmission circuitry 10a may generate and transmit a baseband signal of the UL PTRS. For example, the radio transmission circuitry 10a may generate and transmit a baseband signal of the SRS.

For example, the radio reception circuitry 10b may receive and demodulate the PDSCH. For example, the radio reception circuitry 10b may receive and demodulate the PDCCH. For example, the radio reception circuitry 10b may receive and demodulate the PBCH. For example, the radio reception circuitry 10b may receive the synchronization signal. For example, the radio reception circuitry 10b may receive the PDSCH DMRS. For example, the radio reception circuitry 10b may receive the PDCCH DMRS. For example, the radio reception circuitry 10b may receive the CSI-RS. For example, the radio reception circuitry 10b may receive the DL PTRS.

The higher layer processing circuitry 14 outputs uplink data (a transport block) to the radio transmission and/or reception circuitry 10 (or the radio transmission circuitry 10a). The higher layer processing circuitry 14 performs processing operations of the MAC layer, a packet data convergence protocol layer, a radio link control layer, and the RRC layer.

The medium access control layer processing circuitry 15 included in the higher layer processing circuitry 14 performs processing of the MAC layer.

The radio resource control layer processing circuitry 16 included in the higher layer processing circuitry 14 performs processing of the RRC layer. The radio resource control layer processing circuitry 16 manages various pieces of configuration information/parameters (RRC parameters) of the terminal apparatus 1. The radio resource control layer processing circuitry 16 sets the RRC parameters based on an RRC message received from the base station apparatus 3.

The radio transmission and/or reception circuitry 10 (or the radio transmission circuitry 10a) performs processing such as modulation and coding. The radio transmission and/or reception circuitry 10 (or the radio transmission circuitry 10a) generates a physical signal through modulation, coding, and baseband signal generation (conversion into the time-continuous signal) on the uplink data and transmits the physical signal to the base station apparatus 3. The radio transmission and/or reception circuitry 10 (or the radio transmission circuitry 10a) may map the physical signal to a certain BWP (an active uplink BWP) and transmit the physical signal to the base station apparatus 3.

The radio transmission and/or reception circuitry 10 (or the radio reception circuitry 10b) performs processing such as demodulation and decoding. The radio transmission and/or reception circuitry 10 (or the radio reception circuitry 30b) may receive a physical signal in a certain BWP (active downlink BWP) of a certain serving cell. The radio transmission and/or reception circuitry 10 (or the radio reception circuitry 10b) separates, demodulates, and decodes the received physical signal and outputs the decoded information to the higher layer processing circuitry 14. The radio transmission and/or reception circuitry 10 (radio reception circuitry 10b) may perform the channel access procedure prior to the transmission of the physical signal.

The RF circuitry 12 converts (down converts) a signal received via the antenna circuitry 11 into a baseband signal by means of quadrature demodulation and removes unnecessary frequency components. The RF circuitry 12 outputs a processed analog signal to the baseband circuitry 13.

The baseband circuitry 13 converts the analog signal input from the RF circuitry 12 into a digital signal. The baseband circuitry 13 removes a portion corresponding to a Cyclic Prefix (CP) from the converted digital signal, performs a Fast Fourier Transform (FFT) on the signal from which the CP has been removed, and extracts a signal in the frequency domain.

The baseband circuitry 13 performs Inverse Fast Fourier Transform (IFFT) on the uplink data to generate an OFDM symbol, adds a CP to the generated OFDM symbol, generates a baseband digital signal, and converts the baseband digital signal into an analog signal. The baseband circuitry 13 outputs the converted analog signal to the RF circuitry 12.

The RF circuitry 12 removes unnecessary frequency components from the analog signal input from the baseband circuitry 13 through a low-pass filter, up converts the analog signal into a signal having a carrier frequency, and transmits the signal via the antenna circuitry 11. The RF circuitry 12 may have a function of controlling transmission power. The RF circuitry 12 is also referred to as a transmission power control circuitry.

The physical signal (signal) will be described below.

The physical signal is a general term for a downlink physical channel, a downlink physical signal, an uplink physical channel, and an uplink physical channel. The physical channel is a general term for a downlink physical channel and an uplink physical channel. The physical signal is a general term for a downlink physical signal and an uplink physical signal.

The uplink physical channel may correspond to a set of resource elements for conveying information that is generated in a Higher layer. The uplink physical channel may be a physical channel used in the uplink component carrier. The uplink physical channel may be transmitted by the terminal apparatus 1. The uplink physical channel may be received by the base station apparatus 3. In the radio communication system according to an aspect of the present embodiment, at least a part or all of the following uplink physical channels may be used.
Physical Uplink Control CHannel (PUCCH)
Physical Uplink Shared CHannel (PUSCH)
Physical Random Access CHannel (PRACH)

The PUCCH may be used to transmit Uplink Control Information (UCI). The PUCCH may be transmitted for conveying (delivering, transmitting) the uplink control information. The uplink control information may be mapped to the PUCCH. The terminal apparatus 1 may transmit the PUCCH to which the uplink control information is mapped. The base station apparatus 3 may receive the PUCCH to which the uplink control information is mapped.

The uplink control information (uplink control information bit, uplink control information sequence, uplink control information type) includes at least a part or all of Channel State Information (CSI), a Scheduling Request (SR), and Hybrid Automatic Repeat request ACKnowledgement (HARQ-ACK) information.

The channel state information is also referred to as a channel state information bit or a channel state information sequence. The scheduling request is also referred to as a scheduling request bit or a scheduling request sequence. The HARQ-ACK information is also referred to as a HARQ-ACK information bit or a HARQ-ACK information sequence.

The HARQ-ACK information may include at least a HARQ-ACK bit corresponding to a Transport block (TB), The HARQ-ACK may indicate an acknowledgement (ACK) or a negative-acknowledgement (NACK) corresponding to the transport block. The ACK may indicate that decoding of the transport block has been decoded successfully. The NACK may indicate that decoding of the transport block has not been decoded successfully. The HARQ-ACK information may include a HARQ-ACK codebook including one or multiple HARQ-ACK bits.

The transport block is a sequence of information bits delivered from a higher layer. Here, the sequence of information bits is also referred to as a bit sequence. Here, the transport block may be delivered through an UpLink-Shared CHannel (UL-SCH) of a Transport layer.

A HARQ-ACK for the transport block may be referred to as a HARQ-ACK for the PDSCH. The “HARQ-ACK for the PDSCH” indicates the HARQ-ACK for the transport block included in the PDSCH.

The HARQ-ACK may indicate an ACK or a NACK corresponding to one Code Block Group (CBG) included in the transport block.

The scheduling request may be at least used for requesting a resource of the UL-SCH for new transmission. The scheduling request bit may be used for indicating either of a positive SR or a negative SR. The scheduling request bit indicating the positive SR is also referred to as “the positive SR being conveyed”. The positive SR may indicate that the terminal apparatus 1 requests resources of the UL-SCH for initial transmission. The positive SR may indicate that a scheduling request is triggered by a higher layer. The positive SR may be conveyed in a case that the higher layer indicates the scheduling request. The scheduling request bit indicating the negative SR is also referred to as “the negative SR being transmitted”. The negative SR may indicate that the terminal apparatus 1 requests no resources of the UL-SCH for initial transmission. The negative SR may indicate that the scheduling request is not triggered by the higher layer. The negative SR may be conveyed in a case that the higher layer indicates no scheduling request.

Channel state information may include at least a part or all of a Channel Quality Indicator (COD), a Precoder Matrix Indicator (PMI), and a Rank Indicator (RI). The CQI is an indicator related to quality (for example, propagation strength) of a propagation path or quality of a physical channel, and the PMI is an indicator related to a precoder. The RI is an indicator related to a transmission rank (or the number of transmission layers).

The channel state information is an indicator related to a reception state of a physical signal (for example, CSI-RS) at least used for channel measurement. The channel state information may be determined by the terminal apparatus 1 based on the reception state assumed by the physical signal at least used for channel measurement. Channel measurement may include interference measurement.

The PUCCH may correspond to a PUCCH format. The PUCCH may be a set of resource elements used for conveying the PUCCH format. The PUCCH may include the PUCCH format. The PUCCH format may be transmitted with a certain PUCCH format. Note that the PUCCH format may be interpreted as a form of information. The PUCCH format may be interpreted as a set of information set to a certain form of information.

The PUSCH may be used for conveying one or both of the transport block and the uplink control information. The PUSCH may be used for conveying the transport block and the uplink control information delivered by the UL-SCH. The transport block may be mapped to the PUSCH. The transport block delivered by the UL-SCH may be mapped to the PUSCH. The uplink control information may be mapped to the PUSCH. The terminal apparatus 1 may transmit the PUSCH to which one or both of the transport block and the uplink control information are mapped. The base station apparatus 3 may receive the PUSCH to which one or both of the transport block and the uplink control information are mapped.

The PRACH may be transmitted for conveying a random access preamble. The terminal apparatus 1 may transmit the PRACH. The base station apparatus 3 may receive the PRACH. A PRACH sequence x_{u, v}(n) is defined by x_{u, v}(n) =xᵤ(mod(n+Cᵥ, L_{RA}). Here, xᵤ isa Zadoff Chu (ZC) sequence. xᵤ may be defined by xᵤ=exp(−jπui(i+1)/L_{RA}). j is an imaginary unit. ρis ratio of the circumference of a circle to its diameter. Cᵥ corresponds to a cyclic shift of the PRACH sequence. L_{RA} corresponds to the length of the PRACH sequence. L_{RA} is 839, or 139. i is an integer in the range from 0 to L_{RA}−1. u is a sequence index for the PRACH sequence.

For each PRACH occasion, 64 random access preambles are defined. The random access preambles are identified based on the cyclic shift Cᵥ of the PRACH sequence and the sequence index u for the PRACH sequence. Each of the 64 identified random access preambles may be assigned an index.

The uplink physical signal may correspond to a set of resource elements. The uplink physical signal need not be used to convey information generated in a higher layer. Note that the uplink physical signal may be used to convey information generated in a physical layer. The uplink physical signal may be a physical signal used in the uplink component carrier. The terminal apparatus 1 may transmit the uplink physical signal. The base station apparatus 3 may receive the uplink physical signal. In the radio communication system according to an aspect of the present embodiment, at least a part or all of the following uplink physical signals may be used.
UpLink Demodulation Reference Signal (UL DMRS)
Sounding Reference Signal (SRS)
UpLink Phase Tracking Reference Signal (UL PTRS)

The UL DMRS is a general term for a DMRS for the PUSCH and a DMRS for the PUCCH.

A set of antenna ports of the DMRS for the PUSCH (DMRS related to the PUSCH, DMRS included in the PUSCH, DMRS corresponding to the PUSCH) may be given based on a set of antenna ports for the PUSCH. For example, the set of antenna ports of the DMRS for the PUSCH may be the same as a set of antenna ports of the PUSCH.

Transmission of the PUSCH and transmission of the DMRS for the PUSCH may be indicated (or may be scheduled) by one DCI format. The PUSCH and the DMRS for the PUSCH may be collectively referred to as a PUSCH. Transmission of the PUSCH may mean transmission of the PUSCH and the DMRS for the PUSCH.

A propagation path of the PUSCH may be inferred from the DMRS for the PUSCH.

A set of antenna ports of the DMRS for the PUCCH (DMRS related to the PUCCH, DMRS included in the PUCCH, DMRS corresponding to the PUCCH) may be the same as a set of antenna ports of the PUCCH.

Transmission of the PUCCH and transmission of the DMRS for the PUCCH may be indicated (or may be triggered) by one DCI format. One or both of resource element mapping of the PUCCH and resource element mapping of the DMRS for the PUCCH may be given by one PUCCH format. The PUCCH and the DMRS for the PUCCH may be collectively referred to as a PUCCH. Transmission of the PUCCH may mean transmission of the PUCCH and the DMRS for the PUCCH.

A propagation path of the PUCCH may be inferred from the DMRS for the PUCCH.

The downlink physical channel may correspond to a set of resource elements for conveying information generated in a higher layer. The downlink physical channel may be a physical channel used in a downlink component carrier. The base station apparatus 3 may transmit the downlink physical channel. The terminal apparatus 1 may receive the downlink physical channel. In the radio communication system according to an aspect of the present embodiment, at least a part or all of the following downlink physical channels may be used.
Physical Broadcast Channel (PBCH)
Physical Downlink Control Channel (PDCCH)
Physical Downlink Shared Channel (PDSCH)

The PBCH may be transmitted for conveying one or both of a Master Information Block (MIB) and physical layer control information. Here, the physical layer control information is information generated in the physical layer. The MIB is a set of parameters allocated in a Broadcast Control CHannel (BCCH) that is a logical channel of the MAC layer. The BCCH is allocated in the BCH that is a channel of the transport layer. The BCH may be mapped to the PBCH. The terminal apparatus I may receive the PBCH to which one or both of the MIB and the physical layer control information are mapped. The base station apparatus 3 may transmit the PBCH to which one or both of the MIB and/or the physical layer control information are mapped.

For example, the physical layer control information may include 8 bits. The physical layer control information may include at least a part or all of the following 0A to 0D.
0A) Radio frame bit
0B) Half radio frame (half system frame, half frame) bit
0C) SS/PBCH block index bit
0D) Subcarrier offset bit

The radio frame bit is used for indicating a radio frame in which the PBCH is transmitted (radio frame including a slot in which the PBCH is transmitted). The radio frame bit includes 4 bits. The radio frame bit may include 4 bits out of a 10-bit radio frame indicator. For example, the radio frame indicator may be at least used for identifying radio frames from index 0 to index 1023.

The half radio frame bit is used for indicating, out of the radio frame in which the PBCH is transmitted, which of the first five subframes or the last five subframes is used for transmission of the PBCH. Here, the half radio frame may include five subframes. The half radio frame may include the first five subframes out of the 10 subframes included in the radio frame. The half radio frame may include the last five subframes out of the 10 subframes included in the radio frame.

The SS/PBCH block index bit is used for indicating an SS/PBCH block index. The SS/PBCH block index bit includes 3 bits. The SS/PBCH block index bit may include 3 bits out of a 6-bit SS/PBCH block index indicator. The SS/PBCH block index indicator may be at least used for identifying SS/PBCH blocks from index 0 to index 63.

The subcarrier offset bit is used for indicating a subcarrier offset. The subcarrier offset may be used for indicating a difference between the first subcarrier to which the PBCH is mapped and the first subcarrier to which the control resource set having an index of 0 is mapped.

The PDCCH may be used for transmitting Downlink Control Information (DCI). The downlink control information may be mapped to the PDCCH. The terminal apparatus 1 may receive the PDCCH to which the downlink control information is mapped. The base station apparatus 3 may transmit the PDCCH to which the downlink control information is mapped.

The downlink control information may be transmitted with a DCI format. Note that the DCI format may also be interpreted to be in the format of downlink control information. The DCI format may be interpreted as a set of downlink control information set to a certain format of downlink control information.

A DCI format 0_0, a DCI format 0_1, a DCI format 1_0, and a DCI format 1_1 are DCI formats. An uplink DCI format is a general term for the DCI format 0_0 and the DCI format 0_1. A downlink DCI format is a general term for the DCI format 1_0 and the DCI format 1_1.

The DCI format 0_0 is at least used for scheduling of the PUSCH mapped to a certain cell. The DCI format 0_0 includes at least a part or all of fields listed from 1A to 1E.
1A) Identifier field for DCI formats
1B) Frequency domain resource assignmentfield
1C) Time domain resource assignment field
1D) Frequency hopping flag field
1E) Modulation and Coding Scheme (MCS) field

The identifier field for DCI formats may indicate whether the DCI format including the identifier field for DCI formats is an uplink DCI format or a downlink DCI format. In other words, each of the uplink DCI format and the downlink DCI format may include the identifier field for DCI formats. Here, the identifier field for DCI formats included in the DCI format 0_0 may indicate 0.

A frequency domain resource assignment field included in the DCI format 0_0 may be used for indicating assignment of frequency resources for the PUSCH.

A time domain resource assignment field included in the DCI format 0_0 may be used for indicating assignment of time resources for the PUSCH.

A frequency hopping flag field may be used for indicating whether frequency hopping is applied to the PUSCH.

An MCS field included in the DCI format 0_0 may be at least used for indicating one or both of a modulation scheme for the PUSCH and a target coding rate. The target coding rate may be a target coding rate for the transport block mapped to the PUSCH. The Transport Block Size (TBS) of the PUSCH mapped to the PUSCH may be determined based on one or both of the target coding rate and the modulation scheme for the PUSCH.

The DCI format 0_0 need not include a field used for a CSI request.

The DCI format 0_0 need not include a carrier indicator field. In other words, for the uplink component carrier to which the PUSCH scheduled by the DCI format 0_0 is mapped, the serving cell to which this uplink component carrier belongs may be the same as the serving cell of the uplink component carrier to which the PDCCH including the DCI format 0_0 is mapped. Based on detection of the DCI format 0_0 in a certain downlink component carrier of a certain serving cell, the terminal apparatus 1 may recognize that the PUSCH scheduled by the DCI format 0_0 is mapped to the uplink component carrier of the certain serving cell.

The DCI format 0_0 need not include the BWP field. Here, the DCI format 0_0 may be a DCI format for scheduling the PUSCH without changing the active uplink BWP. The terminal apparatus 1 may recognize that the PUSCH is transmitted without switching the active uplink BWP based on detection of the DCI format 0_0 used for the scheduling of the PUSCH.

The DCI format 0_1 is at least used for scheduling of the PUSCH of a certain cell (mapped to a certain cell). The DCI format 0_1 includes at least a part or all of fields listed from 2A to 2H.
2A) Identifier field for DCI formats
2B) Frequency domain resource assignment field
2C) Uplink time domain resource assignment field
2D) Frequency hopping flag field
2E) MCS field
2F) CSI request field
2G) BWP field
2H) Carrier indicator field

The identifier field for DCI formats included in the DCI format 0_1 may indicate 0.

The frequency domain resource assignment field included in the DCI format 0_1 may be used for indicating assignment of frequency resources for the PUSCH.

The time domain resource assignment field included in the DCI format 0_1 may be used for indicating assignment of time resources for the PUSCH.

The MCS field included in the DCI format 0_1 may be at least used for indicating a part or all of a modulation scheme for the PUSCH and/or a target coding rate.

The BWP field of the DCI format 0_1 may be used for indicating an uplink BWP to which the PUSCH scheduled by the DCI format 0_1 is mapped. In other words, the DCI format 0_1 may be accompanied by a change in the active uplink BWP. The terminal apparatus 1 may recognize the uplink BWP to which the PUSCH is mapped based on detection of the DCI format 0_1 used for scheduling of the PUSCH.

The DCI format 0_1 not including the BWP field may be a DCI format for scheduling the PUSCH without changing the active uplink BWP. The terminal apparatus 1 may recognize that the PUSCH is transmitted without switching the active uplink BWP based on detection of the DCI format D0_1 which is the DCI format 0_1 used for the scheduling of the PUSCH and does not include the BWP field.

In a case that the BWP field is included in the DCI format 0_1 but the terminal apparatus 1 does not support the function of switching the BWP according to the DCI format 0_1, the terminal apparatus 1 may ignore the BWP field. In other words, the terminal apparatus 1 which does not support the function of switching the BWP may recognize that the PUSCH is transmitted without switching the active uplink BWP based on detection of the DCI format 0_1 which is the DCI format 0_1 used for the scheduling of the PUSCH and includes the BWP field. Here, in a case of supporting the function of switching the BWP, the terminal apparatus 1 may report, in a function information reporting procedure of the RRC layer, that “the terminal apparatus 1 supports the function of switching the BWP”.

The CSI request field is used for indicating the report of the CSI.

In a case that the carrier indicator field is included in the DCI format 0_1, the carrier indicator field may be used for indicating the uplink component carrier to which the PUSCH is mapped. In a case that the carrier indicator field is not included in the DCI format 0_1, the uplink component carrier to which the PUSCH is mapped may be the same as the uplink component carrier to which the PDCCH including the DCI format 0_1 used for scheduling of the PUSCH is mapped. In a case that the number of uplink component carriers configured for the terminal apparatus 1 in a certain serving cell group is two or more (case that uplink carrier aggregation is operated in a certain serving cell group), the number of bits of the carrier indicator field included in the DCI format 0_1 used for scheduling of the PUSCH mapped to the certain serving cell group may be 1 bit or more (for example, 3 bits). In a case that the number of uplink component carriers configured for the terminal apparatus 1 in a certain serving cell group is one (case that uplink carrier aggregation is not operated in a certain serving cell group), the number of bits of the carrier indicator field included in the DCI format 0_1 used for scheduling of the PUSCH mapped to the certain serving cell group may be 0 bits (or the carrier indicator field need not be included in the DCI format 0_1 used for scheduling of the PUSCH mapped to the certain serving cell group).

The DCI format 1_0 is at least used for scheduling of the PDSCH mapped to a certain cell. The DCI format 1_0 includes at least a part or all of 3A to 3F.
3A) Identifier field for DCI formats
3B) Frequency domain resource assignment field
3C) Time domain resource assignment field
3D) MCS field
3E) PDSCH to HARQ feedback timing indicator field
3F) PUCCH resource indicator field

The identifier field for DCI formats included in the DCI format 1_0 may indicate 1.

The frequency domain resource assignment field included in the DCI format 1_0 may be at least used for indicating assignment of frequency resources for the PDSCH.

The time domain resource assignment field included in the DCI format 1_0 may be at least used for indicating assignment of time resources for the PDSCH.

The MCS field included in the DCI format 1_0 may be at least used for indicating one or both of the modulation scheme for the PDSCH and the target coding rate. The target coding rate may be a target coding rate for the transport block mapped to the PDSCH. The Transport Block Size (TBS) of the PDSCH mapped to the PDSCH may be determined based on one or both of the target coding rate and the modulation scheme for the PDSCH.

The PDSCH HARQ feedback timing indicator field may be used for indicating an offset from the slot including the last OFDM symbol of the PDSCH to the slot including the first OFDM symbol of the PUCCH.

The PUCCH resource indicator field may be a field indicating an index of one of one or multiple PUCCH resources included in a PUCCH resource set. The PUCCH resource set may include one or multiple PUCCH resources.

The DCI format 1_0 need not include the carrier indicator field. In other words, the downlink component carrier to which the PDSCH scheduled by using a DCI format 1_0 is mapped may be the same as the downlink component carrier to which the PDCCH including the DCI format 1_0 is mapped. Based on detection of the DCI format 1_0 in a certain downlink component carrier, the terminal apparatus 1 may recognize that the PDSCH scheduled by the DCI format 1_0 is mapped to the downlink component carrier.

The DCI format 1_0 need not include the BWP field. Here, DCI format 1_0 may be a DCI format for scheduling the PDSCH without changing the active downlink BWP. The terminal apparatus 1 may recognize that the PDSCH is received without switching the active downlink BWP based on detection of the DCI format 1_0 used in the scheduling of the PDSCH.

The DCI format 1_1 is at least used for scheduling of the PDSCH mapped to a certain cell). The DCI format 1_1 includes at least a part or all of 4A to 4I.
4A) Identifier field for DCI formats
4B) Frequency domain resource assignment field
4C.) Time domain resource assignment field
4E) MCS field
4F) PDSCH to HARQ feedback timing indicator field
4G) PUCCH resource indicator field
4H) BWP field
4I) Carrier indicator field

The identifier field for DCI formats included in the DCI format 1_1 may indicate 1.

The frequency domain resource assignment field included in the DCI format 1_1 may be at least used for indicating assignment of frequency resources for the PDSCH.

The time domain resource assignment field included in the DCI format 1_1 may be at least used for indicating assignment of time resources for the PDSCH.

The MCS field included in the DCI format 1_1 may be at least used for indicating one or both of the modulation scheme for the PDSCH and the target coding rate.

In a case that the PDSCH to HARQ feedback timing indicator field is included in the DCI format 1_1, the PDSCH to HARQ feedback timing indicator field may be at least used for indicating an offset from the slot including the last OFDM symbol of the PDSCH to the slot including the first OFDM symbol of the PUCCH. In a case that the PDSCH to HARQ feedback timing indicator field is not included in the DCI format 1_1, an offset from the slot including the last OFDM symbol of the PDSCH to the slot including the first OFDM symbol of the PUCCH may be identified by a higher layer parameter.

The PUCCH resource indicator field may be a field indicating an index of one of one or multiple PUCCH resources included in a PUCCH resource set.

The BWP field of the DCI format 1_1 may be used to indicate the downlink BWP to which the PDSCH scheduled by the DCI format 1_1 is mapped. In other words, the DCI format 1_1 may be accompanied by a change in the active downlink BWP. The terminal apparatus 1 may recognize the downlink BWP to which the PUSCH is mapped based on detection of the DCI format 1_1 used for the scheduling of the PDSCH.

The DCI format 1_1 not including the BWP field may be a DCI format for scheduling the PDSCH without changing the active downlink BWP. The terminal apparatus 1 may recognize that the PDSCH is received without switching the active downlink BWP based on detection of the DCI format 1_1 which is used for the scheduling of the PDSCH and does not include the BWP field.

In a case that the DCI format 1_1 includes the BWP field but the terminal apparatus 1 does not support the function of switching the BWP according to the DCI format 1_1, the terminal apparatus 1 may ignore the BWP field. In other words, the terminal apparatus 1 which does not support the function of switching the BWP may recognize that the PDSCH is received without switching the active downlink BWP based on detection of the DCI format 1 1 which is used for the scheduling of the PDSCH and includes the BWP field. Here, in a case of supporting the function of switching the BWP, the terminal apparatus 1 may report, in a function information reporting procedure of the RRC layer, that “the terminal apparatus 1 supports the function of switching the BWP”.

In a case that the carrier indicator field is included in the DCI format 1_1, the carrier indicator field may be used for indicating the downlink component carrier to which the PDSCH is mapped. In a case that the carrier indicator field is not included in the DCI format 1_1, the downlink component carrier to which the PDSCH is mapped may be the same as the downlink component carrier to which the PDCCH including the DCI format 1_1 used for scheduling of the PDSCH is mapped. In a case that the number of downlink component carriers configured for the terminal apparatus 1 in a certain serving cell group is two or more (case that downlink carrier aggregation is operated in a certain serving cell group), the number of bits of the carrier indicator field included in the DCI format 1_1 used for scheduling of the PDSCH mapped to the certain serving cell group may be 1 bit or more (for example, 3 bits). In a case that the number of downlink component carriers configured for the terminal apparatus 1 in a certain serving cell group is one (case that downlink carrier aggregation is not operated in a certain serving cell group), the number of bits of the carrier indicator field included in the DCI format 1_1 used for scheduling of the PDSCH mapped to the certain serving cell group may be 0 bits (or the carrier indicator field need not be included in the DCI format 1_1 used for scheduling of the PDSCH mapped to the certain serving cell group).

The PDSCH may be used for conveying the transport block. The PDSCH may be used for transmitting the transport block delivered by the DL-SCH. The PDSCH may be used for conveying the transport block. The transport block may be mapped to the PDSCH. The transport block corresponding to the DL-SCH may be mapped to the PDSCH. The base station apparatus 3 may transmit the PDSCH. The terminal apparatus 1 may receive the PDSCH.

The downlink physical signal may correspond to a set of resource elements. The downlink physical signal need not carry information generated in a higher layer. The downlink physical signal may be a physical signal used in the downlink component carrier. The downlink physical signal may be transmitted by the base station apparatus 3. The downlink physical signal may be transmitted by the terminal apparatus 1. In the radio communication system according to an aspect of the present embodiment, at least a part or all of the following downlink physical signals may be used.
Synchronization signal (SS)
DownLink DeModulation Reference Signal (DL DMRS)
Channel State Information-Reference Signal (CSI-RS)
DownLink Phase Tracking Reference Signal (DL PTRS)

The synchronization signal may be used for the terminal apparatus 1 to take synchronization in one or both of the frequency domain and the time domain in the downlink. The synchronization signal is a general term for the Primary Synchronization Signal (PSS) and the Secondary Synchronization Signal (SSS).

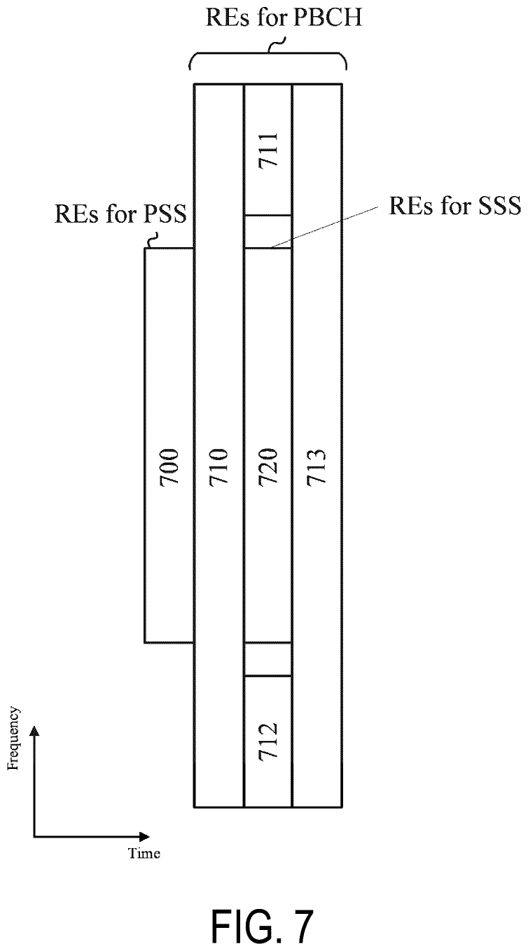

FIG. 7 is a diagram illustrating a configuration example of the SS/PBCH block according to an aspect of the present embodiment. In FIG. 7, the horizontal axis corresponds to a time axis (OFDM symbol index Isym), and the vertical axis represents the frequency domain. A block 700 represents a set of resource elements for the PSS. A block 720 represents a set of resource elements for the SSS. Four blocks (blocks 710, 711, 712, and 713) represent a set of resource elements for the PBCH and the DMRS for the PBCH (DMRS related to the PBCH, DMRS included in the PBCH, DMRS corresponding to the PBCH).

As illustrated in FIG. 7, the SS/PBCH block includes the PSS, the SSS, and the PBCH. The SS/PBCH block includes four consecutive OFDM symbols. The SS/PBCH block includes 240 subcarriers. The PSS is mapped to the 57th to 183rd subcarriers in the first OFDM symbol. The SSS is mapped to the 57th to 183rd subcarriers in the third OFDM symbol. Zero may be set to the 1st to 56th subcarriers of the first OFDM symbol. Zero may be set to the 184th to 240th subcarriers of the first OFDM symbol. Zero may be set to the 49th to 56th subcarriers of the third OFDM symbol. Zero may be set to the 184th to 192nd subcarriers of the third OFDM symbol. The PBCH is mapped to subcarriers which are the 1st to 240th subcarriers of the second OFDM symbol and to which the DMRS for the PBCH is not mapped. The PBCH is mapped to subcarriers which are the 1st to 48th subcarriers of the third OFDM symbol and to which the DMRS for the PBCH is not mapped. The PBCH is mapped to subcarriers which are the 193rd to 240th subcarriers of the third OFDM symbol and to which the DMRS for the PBCH is not mapped. The PBCH is mapped to subcarriers which are the 1st to 240th subcarriers of the fourth OFDM symbol and to which the DMRS for the PBCH is not mapped.

The PSS, the SSS, the PBCH, and the antenna port of the DMRS for the PBCH may be the same.

The PBCH over which the symbol of the PBCH on a certain antenna port is conveyed may be inferred from the DMRS for the PBCH mapped to the slot to which the PBCH is mapped and for the PBCH included in the SS/PBCH block including the PBCH.

The DL DMRS is a general term for a DMRS for the PBCH, a DMRS for the PDSCH, and a DMRS for the PDCCH.

A set of antenna ports of the DMRS for the PDSCH (DMRS related to the PDSCH, DMRS included in the PDSCH, DMRS corresponding to the PDSCH) may be given based on a set of antenna ports for the PDSCH. In other words, the set of antenna ports of the DMRS for the PDSCH may be the same as the set of antenna ports for the PDSCH.

Transmission of the PDSCH and transmission of the DMRS for the PDSCH may be indicated (or may be scheduled) by one DCI format. The PDSCH and the DMRS for the PDSCH may be collectively referred to as a PDSCH. Transmission of the PDSCH may be transmission of the PDSCH and the DMRS for the PDSCH.

A propagation path of the PDSCH may be inferred from the DMRS for the PDSCH. In a case that a set of resource elements in which the symbol of a certain PDSCH is conveyed and a set of resource elements in which the symbol of the DMRS for the certain PDSCH is conveyed are included in the same Precoding Resource Group (PRG), the PDSCH over which the symbol of the PDSCH on a certain antenna port is conveyed may be inferred from the DMRS for the PDSCH.

The antenna port of the DMRS for the PDCCH (DMRS related to the PDCCH, DMRS included in the PDCCH, DMRS corresponding to the PDCCH) may be the same as the antenna port for the PDCCH.

The PDCCH may be inferred from the DMRS for the PDCCH. In other words, a propagation path of the PDCCH may be inferred from the DMRS for the PDCCH. In a case that the same precoder is (assumed to be) applied to a set of resource elements in which the symbol of a certain PDCCH is conveyed and a set of resource elements in which the symbol of the DMRS for the certain PDCCH is conveyed, the PDCCH over which the symbol of the PDCCH on a certain antenna port is conveyed may be inferred from the DMRS for the PDCCH.

A Broadcast CHannel (BCH), an Uplink-Shared CHannel (UL-SCH), and a Downlink-Shared CHannel (DL-SCH) are transport channels. A transport channel defines the relationship between a physical layer channel and a MAC layer channel (also referred to as a logical channel).

The BCH of the transport layer is mapped to the PBCH of the physical layer. In other words, a transport block passing through the BCH of the transport layer is delivered to the PBCH of the physical layer. The UL-SCH of the transport layer is mapped to the PUSCH of the physical layer. In other words, the transport block passing through the UL-SCH of the transport layer is delivered to the PUSCH of the physical layer. The DL-SCH of the transport layer is mapped to the PDSCH of the physical layer. In other words, a transport block passing through the DL-SCH of the transport layer is delivered to the PDSCH of the physical layer.

For each serving cell, one UL-SCH and one DL-SCH may be given. The BCH may be given to the PCell. The BCH need not be given to the PSCell and the SCell.

The MAC layer controls the Hybrid Automatic Repeat reQuest (HARQ) for each transport block.

A Broadcast Control CHannel (BCCH), a Common Control CHannel (CCCH), and a Dedicated Control CHannel (DCCH) are logical channels. For example, the BCCH is a channel of the RRC layer used for transmitting the MIB or system information. The Common Control CHannel (CCCH) may be used for transmitting a common RRC message in multiple terminal apparatuses 1. Here, the CCCH may be, for example, used for the terminal apparatus 1 that is not in a state of RRC connection. The Dedicated Control CHannel (DCCH) may be at least used for transmitting an RRC message dedicated to the terminal apparatus 1. Here, the DCCH may be, for example, used for the terminal apparatus 1 that is in a state of RRC connection.

The higher layer parameter common to the multiple terminal apparatuses 1 is also referred to as a common higher layer parameter. Here, the common higher layer parameter may be defined as a parameter specific to the serving cell. Here, the parameter specific to the serving cell may be a parameter common to terminal apparatuses configured with the serving cell (for example, the terminal apparatuses 1-A, 1-B, and 1-C).

For example, an RRC message delivered to the BCCH may include the common higher layer parameter. For example, an RRC message delivered on the DCCH may include the common higher layer parameter.

Among certain higher layer parameters, a higher layer parameter different from the common higher layer parameter is also referred to as a dedicated higher layer parameter. Here, the dedicated higher layer parameter may provide a dedicated RRC parameter to the terminal apparatus 1-A configured with the serving cell. In other words, the dedicated RRC parameter is a higher layer parameter capable of providing a unique configuration to each of the terminal apparatuses 1-A, 1-B, and 1-C.

The BCCH of the logical channel may be mapped to the BCH or the DL-SCH of the transport layer. For example, a transport block including the information of the MIB is delivered to the BCH of the transport layer. A transport block including system information other than the MIB is delivered to the DL-SCH of the transport layer. The CCCH is mapped to the DL-SCH or the UL-SCH. In other words, a transport block mapped to the CCCH is delivered to the DL-SCH or the UL-SCH. The DCCH is mapped to the DL-SCH or the UL-SCH. In other words, a transport block mapped to the DCCH is delivered to the DL-SCH or the UL-SCH.

The RRC message includes one or multiple parameters managed in the RRC layer. Here, the parameters managed in the RRC layer are also referred to as RRC parameters. For example, the RRC message may include the MIB. The RRC message may include the system information. The RRC message may include a message corresponding to the CCCH. The RRC message may include a message corresponding to the DCCH. The RRC message including a message corresponding to the DCCH is also referred to as a dedicated RRC message.

The higher layer parameter is an RRC parameter or a parameter included in a Medium Access Control Control Element (MAC CE). In other words, the higher layer parameter is a general term for the MIB, the system information, a message corresponding to the CCCH, a message corresponding to the DCCH, and parameters included in the MAC CE. The parameters included in the MAC CE are transmitted by a MAC Control Element (CE) command.

Procedures performed by the terminal apparatus 1 include at least a part or all of the following 5A to 5C.
5A) Cell search
5B) Random access 5C) Data communication

The cell search is a procedure used for the terminal apparatus 1 synchronizing with a certain cell related to the time domain and the frequency domain and detecting a physical cell identity (physical cell ID). In other words, by means of the cell search, the terminal apparatus 1 may perform synchronization with a certain cell in the time domain and the frequency domain and detect a physical cell ID.

A sequence of the PSS is given based at least on the physical cell ID. A sequence of the SSS is given based at least on the physical cell ID.

An SS/PBCH block candidate indicates a resource allowed to (possible to, scheduled to, configured to, defined to, having a possibility to) transmit the SS/PBCH block.

A set of SS/PBCH block candidates in a certain half radio frame is also referred to as an SS burst set. The SS burst set is also referred to as a transmission window, an SS transmission window, or a Discovery Reference Signal transmission window (DRS transmission window). The SS burst set is a general term including at least a first SS burst set and a second SS burst set.

The base station apparatus 3 transmits SS/PBCH blocks with one or multiple indices in a prescribed periodicity. The terminal apparatus 1 may detect at least one SS/PBCH block out of the SS/PBCH blocks with one or multiple indices and attempt decoding of the PBCH included in the at least one SS/PBCH block.

The random access is a procedure including at least a part or all of a message 1, a message 2, a message 3, and a message 4.

The message 1 is a procedure in which the PRACH is transmitted by the terminal apparatus 1. The terminal apparatus 1 transmits the PRACH in one PRACH occasion selected out of one or multiple PRACH occasions based at least on the index of the SS/PBCH block candidate detected based on the cell search. Each of the PRACH occasions is defined based at least on resources in the time domain and the frequency domain.

The terminal apparatus 1 transmits one random access preamble selected out of the PRACH occasions corresponding to the indices of the SS/PBCH block candidates in which the SS/PBCH block is detected.

The message 2 is a procedure for attempting to detect a DCI format 1_0 with a Cyclic Redundancy Check (CRC) scrambled by a Random Access-Radio Network Temporary Identifier (RA-RNTI) by the terminal apparatus 1. The terminal apparatus 1 attempts detection of the PDCCH including the DCI format in a control resource set given based on the MIB, which is included in the PBCH included in the SS/PBCH block detected based on cell search, and in resources indicated based on a configuration of a search space set. The message 2 is also referred to as a random access response.

The message 3 is a procedure for transmitting the PUSCH scheduled by using a random access response grant included in a DCI format 1_0 detected through the procedure of the message 2. Here, the random access response grant is indicated by the MAC CE included in the PDSCH scheduled by using the DCI format 1_0.

The PUSCH scheduled based on the random access response grant is either a message 3 PUSCH or a PUSCH. The message 3 PUSCH includes a contention resolution identifier (contention resolution ID) MAC CE. The contention resolution ID MAC CE includes a contention resolution ID.

Retransmission of the message 3 PUSCH is scheduled by using a DCI format 0_0 with a CRC scrambled based on a Temporary Cell-Radio Network Temporary Identifier (TC-RNTI).

The message 4 is a procedure for attempting to detect a DCI format 1_0 with a CRC scrambled based on either of a Cell-Radio Network Temporary Identifier (C-RNTI) or a TC-RNTI. The terminal apparatus 1 receives a PDSCH scheduled based on the DCI format 1_0. The PDSCH may include a contention resolution ID.

Data communication is a general term for downlink communication and uplink communication.

In the data communication, the terminal apparatus 1 attempts detection of the PDCCH (monitors the PDCCH, supervises the PDCCH) in a control resource set and resources identified based on a search space set.

The control resource set is a set of resources including a certain number of resource blocks and a certain number of OFDM symbols. In the frequency domain, the control resource set may include continuous resources (non-interleaved mapping) or may include distributed resources (interleaver mapping).

A set of resource blocks constituting the control resource set may be indicated by the higher layer parameter. The number of OFDM symbols constituting the control resource set may be indicated by the higher layer parameter.

The terminal apparatus 1 attempts detection of the PDCCH in a search space set. Here, an attempt to detect the PDCCH in the search space set may be an attempt to detect a candidate of the PDCCH in the search space set, may be an attempt to detect a DCI format in the search space set, may be an attempt to detect the PDCCH in the control resource set, may be an attempt to detect a candidate of the PDCCH in the control resource set, or may be an attempt to detect a DCI format in the control resource set.

The search space set is defined as a set of candidates of the PDCCH. The search space set may be a Common Search Space (CSS) set or may be a UE-specific Search Space (USS) set.

The terminal apparatus 1 attempts detection of candidates of the PDCCH in a part or all of a Type 0 PDCCH common search space set, a Type Oa PDCCH common search space set, a Type 1 PDCCH common search space set, a Type 2 PDCCH common search space set, a Type 3 PDCCH common search space set, and/or a UE-specific PDCCH search space set (UE-specific search space set).

The Type 0 PDCCH common search space set may be used as a common search space set having an index of 0. The Type 0 PDCCH common search space set may be a common search space set having an index of 0.

The CSS set is a general term for the Type 0 PDCCH common search space set, the Type Oa PDCCH common search space set, the Type 1 PDCCH common search space set, the Type 2 PDCCH common search space set, and the Type 3 PDCCH common search space set. The USS set is also referred to as a UE-specific PDCCH search space set.

A certain search space set is related to (included in, corresponds to) a certain control resource set. The index of the control resource set related to the search space set may be indicated by the higher layer parameter.

For a certain search space set, a part or all of 6A to 6C may be indicated by at least the higher layer parameter.
6A) PDCCH monitoring periodicity
6B) PDCCH monitoring pattern within a slot
6C) PDCCH monitoring offset

The monitoring occasion of a certain search space set may correspond to the OFDM symbol to which the first OFDM symbol of a control resource set related to the certain search space set is mapped. The monitoring occasion of a certain search space set may correspond to a resource of a control resource set starting from the first OFDM symbol of the control resource set related to the certain search space set. The monitoring occasion of the search space set is given based at least on a part or all of the monitoring periodicity of the PDCCH, the monitoring pattern of the PDCCH in a slot, and the monitoring offset of the PDCCH.

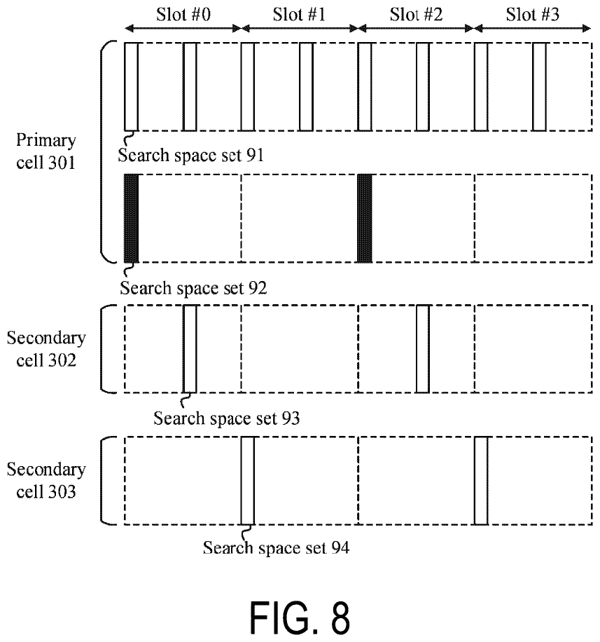

FIG. 8 is a diagram illustrating an example of the monitoring occasions for the search space sets according to an aspect of the present embodiment. In FIG. 8, a search space set 91 and a search space set 92 are configured in a primary cell 301, a search space set 93 is configured in a secondary cell 302, and a search space set 94 is configured in a secondary cell 303.

In FIG. 8, solid white blocks in the primary cell 301 represent a search space set 91, solid black blocks in the primary cell 301 represent a search space set 92, blocks in the secondary cell 302 represent a search space set 93, and blocks in the secondary cell 303 represent a search space set 94.

The monitoring periodicity of the search space set 91 is set to one slot, the monitoring offset of the search space set 91 is set to zero slots, and the monitoring pattern of the search space set 91 is set to [1, 0, 0, 0, 0, 0, 0, 1, 0, 0, 0, 0, 0, 0]. In other words, the monitoring occasions for the search space set 91 corresponds to the first OFDM symbol (OFDM symbol #0) and the eighth OFDM symbol (OFDM symbol #7) in each of the slots.

The monitoring periodicity of the search space set 92 is set to two slots, the monitoring offset of the search space set 92 is set to zero slots, and the monitoring pattern of the search space set 92 is set to [1, 0, 0, 0, 0, 0, 0, 0, 0, 0, 0, 0, 0, 0]. In other words, the monitoring occasion for the search space set 92 corresponds to the first OFDM symbol (OFDM symbol #0) in each of the even-numbered slots.

The monitoring periodicity of the search space set 93 is set to two slots, the monitoring offset of the search space set 93 is set to zero slots, and the monitoring pattern of the search space set 93 is set to [0, 0, 0, 0, 0, 0, 0, 1, 0, 0, 0, 0, 0, 0]. In other words, the monitoring occasion for the search space set 93 corresponds to the eighth OFDM symbol (OFDM symbol #7) in each of the even-numbered slots.

The monitoring periodicity of the search space set 94 is set to two slots, the monitoring offset of the search space set 94 is set to one slot, and the monitoring pattern of the search space set 94 is set to [1, 0, 0, 0, 0, 0, 0, 0, 0, 0, 0, 0, 0, 0]. In other words, the monitoring occasion for the search space set 94 corresponds to the first OFDM symbol (OFDM symbol #0) in each of the odd-numbered slots.

The Type 0 PDCCH common search space set may be at least used for the DCI format with a Cyclic Redundancy Check (CRC) sequence scrambled by a System Information-Radio Network Temporary Identifier (SI-RNTI).

The Type 0a PDCCH common search space set may be at least used for the DCI format with a Cyclic Redundancy Check (CRC) sequence scrambled by a System Information-Radio Network Temporary Identifier (SI-RNTI).

The Type 1 PDCCH common search space set may be at least used for the DCI format with a CRC sequence scrambled by a Random Access-Radio Network Temporary Identifier (RA-RNTI) and/or a CRC sequence scrambled by a Temporary Cell-Radio Network Temporary Identifier (TC-RNTI).

The Type 2 PDCCH common search space set may be used for the DCI format with a CRC sequence scrambled by a Paging-Radio Network Temporary Identifier (P-RNTI).

The Type 3 PDCCH common search space set may be used for the DCI format with a CRC sequence scrambled by a Cell-Radio Network Temporary Identifier (C-RNTI).

The UE-specific PDCCH search space set may be at least used for the DCI format with a CRC sequence scrambled by a C-RNTI.

In the downlink communication, the terminal apparatus 1 detects a downlink DCI format. The detected downlink DCI format is at least used for resource assignment of the PDSCH. The detected downlink DCI format is also referred to as a downlink assignment. The terminal apparatus 1 attempts reception of the PDSCH. Based on the PUCCH resource indicated based on the detected downlink DCI format, the HARQ-ACK corresponding to the PDSCH (HARQ-ACK corresponding to the transport block included in the PDSCH) is reported to the base station apparatus 3.

In the uplink communication, the terminal apparatus 1 detects an uplink DCI format. The detected DCI format is at least used for resource assignment of the PUSCH. The detected uplink DCI format is also referred to as an uplink grant. The terminal apparatus 1 performs transmission of the PUSCH.

In configured grant, the uplink grant for scheduling the PUSCH is configured for each transmission periodicity of the PUSCH. A part or all of pieces of information indicated by an uplink DCI format in a case that the PUSCH is scheduled by the uplink DCI format may be indicated by the uplink grant configured in a case of the configured grant.

Repetition transmission may be applied for the message 3 PUSCH. For example, the number of repetitions of the message 3 PUSCH scheduled by the DCI format 0_0 with the CRC scrambled based on the TC-RNTI may be determined based at least on the DCI format 0_0. For example, the number of repetitions of the message 3 PUSCH scheduled by the random access response grant may be determined based at least on the random access response grant. The number of repetitions may be the number of slots.

For example, the number of repetitions for the message 3 PUSCH may be determined based at least on one of the first field, the second field, and the third field included in one of the DCI format 0_0 and the random access response grant. The first field may be a time domain resource assignment field. The second field may be an MCS field. The third field may be a Transmission Power Control (TPC) command field.

Performance of frequency hopping may be indicated for the message 3 PUSCH to which the repetition transmission is applied. For example, the manner of frequency hopping corresponding to the above-described frequency hopping may be inter-slot frequency hopping. Performance of frequency hopping may be indicated for the message 3 PUSCH to which the repetition transmission is not applied. For example, the frequency hopping scheme corresponding to the above-described frequency hopping may be intra-slot frequency hopping.

The medium access control layer processing circuitry 15 may perform a random access procedure. The random access procedure may be one of a 4-step random access procedure and a 2-step random access procedure.

In a case that the medium access control layer processing circuitry 15 selects the 4-step random access procedure, the medium access control layer processing circuitry 15 may perform one or both of selection of a random access preamble group and selection of a PRACH resource group.

The random access preamble group may be one of a random access preamble group A and a random access preamble group B. The medium access control layer processing circuitry 15 may select the random access preamble group based at least on the higher layer parameter ra-Msg3SizeGroupA. ra-Msg3SizeGroupA may indicate a threshold for the TBS, and the random access preamble group A may be selected in a case that a message 3 PUSCH including a TB smaller than the threshold for the TBS is transmitted.

One PRACH resource group may include one or multiple PRACH resources. One PRACH resource group may include one or multiple PRACH opportunities.

The terminal apparatus 1 may notify the base station apparatus 3 of the information indicating whether to request application of the repetition transmission to the message 3 PUSCH by using the PRACH transmitted during the random access procedure. For example, transmission of the PRACH based on the first PRACH resource group may correspond to requesting application of the repetition transmission to the message 3 PUSCH. Transmission of the PRACH based on the second PRACH resource group may correspond to not requesting application of repetition transmission to the message 3 PUSCH.

In other words, the fact that the medium access control layer processing circuitry 15 requests application of the repetition transmission to the message 3 PUSCH may mean that the medium access control layer processing circuitry 15 selects the first PRACH resource group. The fact that the medium access control layer processing circuitry 15 does not request application of the repetition transmission to the message 3 PUSCH may mean that the medium access control layer processing circuitry 15 selects the second PRACH resource group.

In the random access procedure, whether the medium access control layer processing circuitry 15 requests application of the repetition transmission to the message 3 PUSCH may be determined based on one or both of a value of Reference Signal Received Power (RSRP) of a downlink path loss reference and whether the random access preamble group B is configured for the first PRACH resource group. The medium access control layer processing circuitry 15 may select the 4-step random access procedure involving requesting application of the repetition transmission to the message 3 PUSCH.

The downlink path loss reference may be one of the SS/PBCH block and the CSI-RS.

The downlink path loss reference may be the SS/PBCH block selected in the random access procedure.

The base station apparatus 3 may set the information (the random access response grant) included in the message 2 PDSCH based on the presence or absence of the request transmitted from the terminal apparatus 1.

In a case that the reception of the message 2 is successfully completed, the medium access control layer processing circuitry 15 may perform processing of the uplink grant (random access response grant) included in the random access response. In processing of the uplink grant, transmission of the message 3 PUSCH may be indicted to the physical layer processing circuitry 10.

PUSCH-Config may be a dedicated higher layer parameter. PUSCH-ConfigCommon may be a common higher layer parameter. PUSCH-Config may be configured per BWP for PUSCH transmission. PUSCH-Config may include multiple higher layer parameters related to the PUSCH transmission. PUSCH-Config may be a UE-specific configuration. For example, PUSCH-Config for the terminal apparatus 1A, and the terminal apparatus 1B, the terminal apparatus 1C in one cell, or multiple higher layer parameters included in PUSCH-Config may vary. PUSCH-ConfigCommon may be configured per BWP for the PUSCH transmission. PUSCH-ConfigCommon may include multiple higher layer parameters related to the PUSCH transmission. PUSCH-ConfigCommon may be a cell-specific configuration. For example, PUSCH-ConfigCommon for the terminal apparatus 1A, and the terminal apparatus 1B, the terminal apparatus 1C in one cell may be common. For example, PUSCH-ConfigCommon may be provided in system information.

The repetition transmission may be applied to the PUSCH scheduled by the DCI. The repetition transmission may be applied to the PUSCH scheduled by the configured uplink grant. The PUSCH repetition type may be one of a PUSCH repetition type A and a PUSCH repetition type B. The PUSCH repetition type may be configured by a higher layer parameter. The PUSCH repetition type may be based on the DCI format. For example, the first PUSCH repetition type for the PUSCH scheduled by the DCI format 0_1 may be different from the second PUSCH repetition type for the PUSCH scheduled by the DCI format 0_2.

The higher layer parameter numberOfRepetitioins may be a parameter indicating the number of repetitions for the PUSCH repetition transmission. For the PUSCH repetition transmission corresponding to the PUSCH repetition type A, the number of repetitions for the PUSCH repetition transmission may be determined according to the value of the higher layer parameter numberOfRepetitions. In the PUSCH repetition type A, for the PUSCH for which transmission is indicated by the DCI format with the CRC scrambled by any one of the C-RNTI, and the MCS-C-RNTI, the CS-RNTI, in a case that the resource assignment table includes numberOfRepetitions, the number of repetitions may be equal to numberOfRepetitions. In a case that one PUSCH-TimeDomainResourceAllocation includes one or multiple PUSCH-Allocations, the higher layer parameter numberOfRepetitions may be configured for each PUSCH-Allocation. PUSCH-TimeDomainResourceAllocation may be referred to as a resource assignment table.

The higher layer parameter pusch-AggregationFactor may be a parameter indicating the number of repetitions for the PUSCH repetition transmission. For the PUSCH repetition transmission corresponding to the PUSCH repetition type A, the number of repetitions for the PUSCH repetition transmission may be determined according to the value of the higher layer parameter pusch-AggregationFactor. In the PUSCH repetition type A, for the PUSCH for which transmission is indicated by the DCI format with the CRC scrambled by any one of the C-RNTI, and the MCS-C-RNTI, the CS-RNTI, in a case that the pusch-AggregationFactor is configured, the number of repetitions may be equal to the pusch-AggregationFactor. pusch-AggregationFactor may be configured for PUSCH-Config.

The number of repetitions corresponding to the PUSCH repetition type A may be the number of slots for the PUSCH repetition transmission. One TB may be repeated in one or multiple slots. Assignment of the same OFDM symbol may be applied to PUSCH repetitions transmitted in different slots.

The PUSCH repetition transmission corresponding to the PUSCH repetition type B may be based on a Nominal Repetition and an Actual Repetition.

The higher layer parameters frequency Hopping, frequencyHoppingDCI-0-1, and frequencyHoppingDCI-0-2 may be parameters indicating a frequency hopping scheme for the PUSCH. For example, the frequency hopping scheme corresponding to the frequency hopping for the PUSCH may be configured by frequency HoppingDCI-0-2 in PUSCH-Config. The frequency hopping scheme corresponding to the frequency hopping for the PUSCH may be configured by frequencyHopping in PUSCH-Config. The frequency hopping scheme may be configured that corresponds to the frequency hopping for the PUSCH transmission configured by frequencyHopping in configuredGrantConfig. The frequency hopping scheme may be any one of intra-slot frequency hopping, inter-slot frequency hopping, inter-repetition frequency hopping, and inter-bundle frequency hopping. The frequency hopping interval corresponding to the intra-slot frequency hopping may be one slot or less. The frequency hopping interval corresponding to the inter-slot frequency hopping may be one slot. The frequency hopping interval corresponding to the inter-repetition frequency hopping may be based on the nominal repetition. The frequency hopping interval corresponding to the inter-bundle frequency hopping may be one or multiple slots. The Bundle may be a time unit including multiple slots. The bundle may be the number of slots corresponding to the frequency hopping interval.

For example, in a case that the first higher layer parameter indicating the frequency hopping scheme for the PUSCH indicates the inter-slot frequency hopping and the bundle is provided by the second higher layer parameter, the inter-bundle frequency hopping may be applied to the PUSCH. For example, in a case that the higher layer parameter indicating the frequency hopping scheme for the PUSCH indicates the inter-bundle frequency hopping, the inter-bundle frequency hopping may be applied to the PUSCH.

For example, the bundle may be provided by a higher layer parameter. For example, in a case that the higher layer parameter indicates N, a bundle of N slots may be provided for the PUSCH to which inter-bundle frequency hopping is applied. The N may be an integer larger than 1. For example, in a case that the higher layer parameter includes one value, the one value may be provided for one or both of the PUSCH and the PUCCH to which inter-bundle frequency hopping is applied. The one value may be a value larger than 1. The one value may be a window length of a configured time domain window.

Whether to perform frequency hopping for the PUSCH for which transmission is indicated by the DCI format may be determined based at least on the value of a frequency hopping flag field included in the DCI format. Whether to perform frequency hopping for the PUSCH for which transmission is indicated by the random access response grant may be determined based at least on the value of the frequency hopping flag field included in the random access response grant. For example, the frequency hopping for the PUSCH may be performed based at least on the value of the frequency hopping flag field being 1.

The intra-slot frequency hopping may be applied to PUSCH transmission in one or multiple slots. For example, the intra-slot frequency hopping may be applied to the PUSCH repetition transmission. For the PUSCH to which the intra-slot frequency hopping is applied, assignment of resource blocks may be switched for every one or multiple OFDM symbols. For example, for the PUSCH to which the intra-slot frequency hopping is applied, switching may be performed for every one or multiple OFDM symbols to determine whether the assignment of the resource blocks corresponds to a first hop or a second hop. In a case that intra-slot frequency hopping is performed for the PUSCH, switching between the first hop and the second hop may be performed for every one or multiple OFDM symbols. There may be a difference of RB_{offset} between the position of the first resource block of the first hop and the position of the first resource block of the second hop. RB_{offset} may be configured by a higher layer parameter. The one or multiple OFDM symbols may be one slot or less. The one or multiple OFDM symbols may be half the number of OFDM symbols for the PUSCH in one slot. The intra-slot frequency hopping may be applied to the PUSCH corresponding to the PUSCH repetition type A.

The inter-slot frequency hopping may be applied to PUSCH transmission in multiple slots. For the PUSCH to which inter-slot frequency hopping is applied, the assignment of the resource blocks may be switched for each slot. For example, the inter-slot frequency hopping may be applied to the PUSCH repetition transmission. In a case that the inter-slot frequency hopping is performed for the PUSCH, switching may be performed for every slot to determine whether the assignment of the resource blocks corresponds to the first hop or the second hop. For example, in a case that a certain slot has a slot index n^{μ}_{s, f} that is even-numbered, the PUSCH transmission in the slot may correspond to the first hop. For example, in a case that the certain slot has a slot index n^{μ}_{s, f} that is odd-numbered, the PUSCH transmission in the slot may correspond to the second hop. The inter-slot frequency hopping may be applied to the PUSCH corresponding to one of the PUSCH repetition type A and the PUSCH repetition type B.

The inter-repetition frequency hopping may be applied to the PUSCH corresponding to the PUSCH repetition type B. For the PUSCH to which the inter-repetition frequency hopping is applied, switching between the first hop and the second hop may be performed based on the nominal repetition.

The inter-bundle frequency hopping may be applied to the PUSCH transmission in multiple slots. For example, the inter-bundle frequency hopping may be applied to the PUSCH repetition transmission. For the PUSCH to which inter-bundle frequency hopping is applied, the assignment of the resource blocks may be switched for each bundle. In a case that the inter-bundle frequency hopping is performed for the PUSCH, switching may be performed for every bundle to determine whether the assignment of resource blocks corresponds to the first hop or the second hop. The bundle may be one or multiple slots. For example, the bundle may be determined by a higher layer parameter. For example, the bundle may be determined based on the number of repetitions. For example, the bundle may include continuous UL slots. For example, the bundle may include a special slot and a UL slot. The inter-bundle frequency hopping may be applied to the PUSCH corresponding to one of the PUSCH repetition type A and the PUSCH repetition type B.

The UL slot may be a slot including UL symbols. The special slot may be a slot including a UL symbol, a flexible symbol, and a DL symbol. The DL slot may be a slot including DL symbols.

The UL symbol may be an OFDM symbol configured or indicated for the uplink in time division duplex. The UL symbol may be an OFDM symbol configured or indicated for the PUSCH, the PUCCH, the PRACH, or the SRS. The UL symbol may be configured by a higher layer parameter tdd-UL-DL-ConfigurationCommon. The UL symbol may be configured by a higher layer parameter tdd-UL-DL-ConfigurationDedicated. The UL slot may be configured by the higher layer parameter tdd-UL-DL-ConfigurationCommon. The UL slot may be configured by the higher layer parameter tdd-UL-DL-ConfigurationDedicated.

The DL symbol may be an OFDM symbol configured or indicated for the downlink in time division duplex. The DL symbol may be an OFDM symbol configured or indicated for the PDSCH or the PDCCH. The DL symbol may be configured by the higher layer parameter tdd-UL-DL-ConfigurationCommon. The DL symbol may be configured by the higher layer parameter tdd-UL-DL-ConfigurationDedicated. The DL slot may be configured by the higher layer parameter tdd-UL-DL-ConfigurationCommon. The DL slot may be configured by the higher layer parameter tdd-UL-DL-ConfigurationDedicated.

The flexible symbol may be an OFDM symbol that is not configured or indicated as a UL symbol or a DL symbol among the OFDM symbols within a certain periodicity. The certain periodicity may be a periodicity given by a higher layer parameter di-UL-TransmissionPeriodicity. The flexible symbol may be an OFDM symbol configured or indicated for the PDSCH, the PDCCH, the PUSCH, the PUCCH, or the PRACH.

The higher layer parameter tdd-UL-DL-ConfigurationCommon may be a parameter that configures one of a UL slot, and a DL slot, a special slot for each of one or multiple slots. The higher layer parameter tdd-UL-DL-ConfigurationDedicated may be a parameter that configures any one of a UL symbol, and a DL symbol, a flexible symbol for a flexible symbol in each of the one or multiple slots. tdd-UL-DL-ConfigurationCommon may be a common higher layer parameter. tdd-UL-DL-ConfigurationDedicated may be a dedicated higher layer parameter.

The Time Domain Window may indicate a time domain period. For example, the time domain window may be used for DMRS Bundling. The terminal apparatus 1 that performs the DMRS bundling may enable channel estimation using DMRSs included in two or more PUSCHs in a period based on the time domain window. The terminal apparatus 1 that performs the DMRS bundling may be expected to maintain one or both of phase continuity and power consistency between two PUSCHs in the period based on the time domain window. The DMRS bundling may be referred to as Joint Channel Estimation.

The time domain window may be a collective term for the Configured Time Domain Window and the Actual Time Domain Window.

The configured time domain window may include one or multiple continuous slots. The configured time domain window may be configured by one or multiple higher layer parameters. For example, the one or multiple higher layer parameters may include one or multiple parameters that can enable the configured time domain window. For example, the one or multiple higher layer parameters may include one or multiple parameters indicating the length of the configured time domain window. The length of the configured time domain window may be referred to as a window length. The configured time domain window may include slots corresponding to the window length. The start position of the configured time domain window may be determined based on the first PUSCH of the PUSCH repetition transmission. For example, the start position of the configured time domain window may be the first slot of the PUSCH repetition transmission. For example, the start position of the configured time domain window may be the first slot in which the PUSCH to which the PUSCH repetition type A is applied is transmitted. For example, the start position of the configured time domain window may be a slot corresponding to the first transmission opportunity for the PUSCH to which the PUSCH repetition type A is applied.

The window length may be determined based on the bundle. For example, the window length may be a bundle. For example, the window length may be used as a bundle for the inter-bundle frequency hopping. For example, one of the first hop and the second hop may correspond to multiple PUSCH transmissions in the configured time domain window. A part or both of the configured time domain window and the window length may be used for precoding. For example, the same precoding may be applied to the multiple PUSCH transmissions in the configured time domain window. A part or both of the configured time domain window and the window length may be used for terminal adjustment of the terminal apparatus 1. For example, frequency out-of-sync need not be corrected in the configured time domain window. For example, in the configured time domain window, temporal timing out-of-sync need not be corrected. For example, antenna virtualization need not be adjusted in the configured time domain window. For example, an analog circuit controlled by digital signals need not be adjusted in the configured time domain window. For example, a high frequency circuit need not be adjusted in the configured time domain window. The adjustment of the high frequency circuit may include a part or all of a change of an operating point in a power amplifier, a change of a gain in the power amplifier, phase synchronization in an oscillator, phase adjustment in two carrier waves, phase adjustment in a phase shifter, and stop of power supply to the high frequency circuit.

The window length may have a predetermined maximum period. For example, the terminal apparatus 1 may report the maximum period to the base station apparatus 3. For example, the maximum period may be the number of repetitions.

One or more window lengths may be configured in the PUSCH-Config. One or multiple window lengths may be configured in PUSCH-ConfigCommon. For example, one of the one or multiple window lengths may be determined based on the DCI format. For example, one of the one or multiple window lengths may be determined based on a time domain resource assignment field included in the DCI.

In Frequency Division Duplex, two or more configured time domain windows may be continuous. For example, the last slot in a first configured time domain window may be continuous with the first slot in a second configured time domain window.

In the time division duplex, two or more configured time domain windows may be continuous. In the time division duplex, the two or more configured time domain windows need not be continuous. For example, the start position of the configured time domain window may be determined based at least on one or both of tdd-UL-DL-ConfigurationCommon and tdd-UL-DL-ConfigurationDedicated. For example, the start position of the configured time domain window need not include DL slot.

The first one of the one or multiple configured time domain windows may end immediately before the DL slot. All of the one or multiple configured time domain windows other than the first configured time domain window may be aligned with the periodicity given di-UL-TransmissionPeriodicity.

The configured time domain window may end based on a certain slot index. For example, in a case that n^{μ}_{s, f} is a first value, the time domain window configured at the end of the slot corresponding to n^{μ}_{s, f} may end. The configured time domain window may be applied to the PUSCH transmitted in the slot. The first value may be 0. The first value may be configured by a higher layer parameter. The first value may be determined based on a certain periodicity. For example, the certain period may be used for processing performed with each certain periodicity. The certain periodicity may be an integer multiple of the window length of the configured time domain window. The first value may be determined by the certain periodicity and the offset. In a case that n^{μ}_{s, f} is the second value, the time domain window configured at the end of the slot corresponding to n^{μ}_{s, f} may end. The difference between the first value and the second value may be the certain periodicity.

The last one of the one or multiple configured time domain windows may end at the slot corresponding to the last PUSCH in the PUSCH repetition transmission.

One or more actual time domain windows may be determined in the configured time domain windows. The multiple actual time domain windows need not be continuous with each other. The terminal apparatus 1 may be expected to maintain phase continuity and power consistency in the actual time domain window. The actual time domain window may include one or multiple slots. The actual time domain window may include one or multiple OFDM symbols.

The actual time domain window may be determined based on an event occurring within the configured time domain window. The actual time domain window may be determined based on the slot or the OFDM symbol corresponding to the event in the configured time domain window. The actual time domain window need not include the slot or the OFDM symbol corresponding to the event in the configured time domain window. For example, the event may include some or all of reception of a downlink physical channel, and transmission of a high-priority channel, a slot format indication, frequency hopping, a cancellation indication.

For example, the slot or the OFDM symbol corresponding to the event may be a slot or an OFDM symbol in which the PUSCH repetition transmission is cancelled. For example, the slot corresponding to the event may be a DL slot. For example, the slot or the OFDM symbol corresponding to the event may be a slot or an OFDM symbol including a DL reception opportunity. For example, the slot or the OFDM symbol corresponding to the event may be a slot or an OFDM symbol in which a high-priority channel is transmitted. For example, the slot corresponding to the event may be a slot indicated as a DL slot or a special slot by the slot format indication. For example, the OFDM symbol corresponding to the event may be an OFDM symbol indicated as a DL symbol or a flexible symbol by the slot format indication. For example, in a case that the n-1th slot is associated with the first hop, the slot corresponding to the event may be the nth slot associated with the second hop. For example, in a case that the n-1th slot is associated with the second hop, the slot corresponding to the event may be the nth slot associated with the first hop. For example, in a case that the n-1th OFDM symbol is associated with the first hop, the OFDM symbol corresponding to the event may be the nth OFDM symbol associated with the second hop. For example, in a case that the n-1th slot is associated with the second hop, the OFDM symbol corresponding to the event may be the nth OFDM symbol associated with the first hop.

The actual time domain window may include an OFDM symbol in which no PUSCH is transmitted. For example, the actual time domain window may include 13 continuous OFDM symbols, and the terminal apparatus 1 need not transmit the uplink physical channel and the uplink physical signal in the 13 continuous OFDM symbols.

The terminal apparatus 1 may maintain phase continuity and transmit power consistency in the actual time domain window based on requirements for phase continuity and transmit power consistency. For example, in the actual time domain window, two OFDM symbols in which an uplink physical channel and an uplink physical signal are transmitted may correspond to the same antenna port. For example, the terminal apparatus 1 may determine, based on whether a certain actual time domain window includes the first channel and the second channel. whether the first channel on which a symbol in a certain antenna port is conveyed should be transmitted in such a manner that the first channel can be estimated from the second channel on which the other symbols in the certain antenna port are conveyed. For example, in a case that the certain actual time domain window includes the first channel and the second channel, the terminal apparatus 1 may transmit the first channel on which the symbol in the certain antenna port is conveyed in such a manner that the first channel can be estimated from the second channel on which the other symbols in the certain antenna port are conveyed. In a case that the certain actual time domain window does not include the first channel or the second channel, the terminal apparatus 1 need not transmit the first channel on which the symbol on the certain antenna port is conveyed can be estimated from the second channel on which the other symbols in the certain antenna port is conveyed. Here, the first channel may be different from the second channel. Alternatively, the first channel may be the same as the second channel. The first channel may be a certain Repetition of third channels, and the second channel may be another repetition of the third channels. For example, the terminal apparatus 1 need not change the parameter related to precoding for the PUCCH and/or the PUSCH within the actual time domain window. For example, the parameter related to precoding may be a precoding matrix for spatial multiplexing. The parameter related to precoding may be a higher layer parameter txConfig. The parameter related to precoding may be a Transmitted Precoding Matrix Indicator (TPMI). The TPMI may be given by the DCI format. The parameter related to the precoding may be an SRS Resource Indicator (SRI). The terminal apparatus 1 may apply one precoding to the repetition of the PUSCH in the actual time domain window. For example, power control may be performed for the first PUSCH in the actual time domain window. Power control need not be performed for one or multiple PUSCHs except for the first PUSCH in the actual time domain window. For example, the value of the TPC command field may be applied for the first PUSCH in the actual time domain window. The value of the TPC command field need not be applied for one or multiple PUSCHs except for the first PUSCH in the actual time domain window. The TPC command field for the PUSCH may be included in some or all of the DCI format 0_0, and the DCI format 0_1, the DCI format 0_2, the DCI format 2_2, the DCI format 2_3, the random access response grant. The terminal apparatus 1 need not perform the frequency hopping for the repetition of the PUSCH in the actual time domain window. Not performing the frequency hopping may mean that the repetition of the PUCCH in the actual time domain window is at least mapped to one of the first hop or the second hop. The terminal apparatus 1 need not perform beam switching on the PUSCH within the actual time domain window. The terminal apparatus 1 need not change the configuration of the modulation scheme and the modulation order for the PUSCH transmission in the actual time domain window. The terminal apparatus 1 need not change the index of the first resource block and the number of resource blocks for the PUSCH transmission in the actual time domain window. One or multiple PUSCHs within the actual time domain window may correspond to the same time domain resource assignment. The same precoding may be applied to one or multiple PUSCHs within the actual time domain window. The same transmission power control may be applied to one or multiple PUSCHs within the actual time domain window. One or multiple PUSCHs within the actual time domain window may be at least located in a same resource block. The terminal apparatus 1 may transmit a baseband signal with an amplitude of 0 between two discontinuous PUSCHs within the actual time domain window.

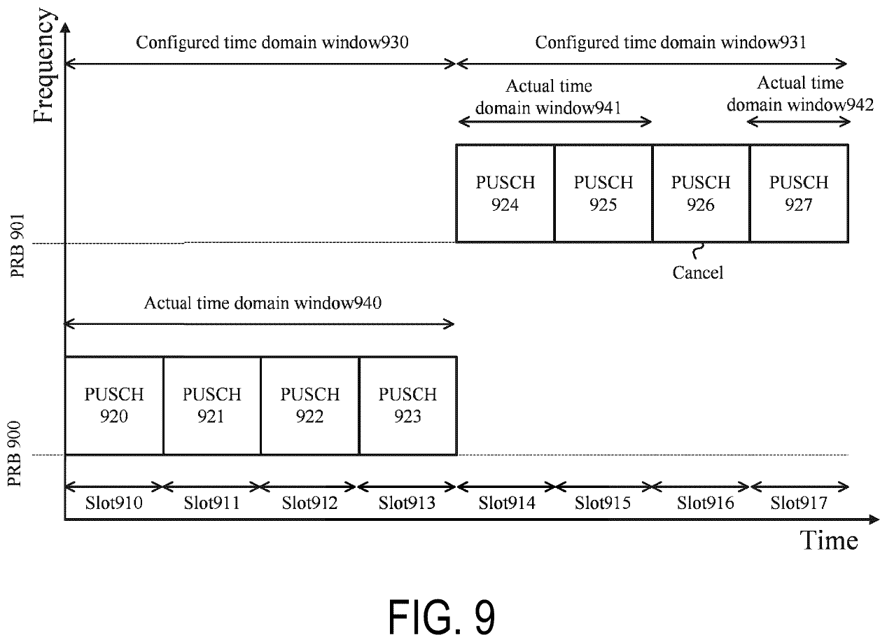

FIG. 9 is a diagram illustrating examples of the configured time domain window and the actual time domain window according to an aspect of the present embodiment. In the uplink BWP in the uplink carrier, the terminal apparatus 1 transmits a PUSCH 920 in a slot 910, transmits a PUSCH 921 in a slot 911, transmits a PUSCH 922 in a slot 912, transmits a PUSCH 923 in a slot 913, transmits a PUSCH 924 in a slot 914, transmits a PUSCH 925 in a slot 915, and transmits a PUSCH 927 in a slot 917. The PUSCH 920, PUSCH 921, PUSCH 922, and PUSCH 923 are PUSCHs starting at a PRB 900. The PRB 900 may be the first hop. The PUSCH 924, PUSCH 925, PUSCH 926, and PUSCH 927 start at a PRB 901. The PRB 901 may be the second hop and may be different from the PRB 900. Frequency hopping may be applied to the PUSCH 920, PUSCH 921, PUSCH 922, PUSCH 923, PUSCH 924, PUSCH 925, PUSCH 926, and PUSCH 927. The PUSCH 926 need not be transmitted in a slot 916. For example, the PUSCH 926 may overlap with an uplink channel having a high priority. For example, cancellation of the transmission of the PUSCH 926 may be indicated. For example, the slot 916 may be a slot corresponding to an event.

In FIG. 9, a configured time domain window 930 includes the PUSCH 920, PUSCH 921, PUSCH 922, and PUSCH 923. A configured time domain window 931 includes the PUSCH 924, PUSCH 925, PUSCH 926, and PUSCH 927. An actual time domain window 940 may include slots or OFDM symbols included in the configured time domain window 930. For example, the actual time domain window 940 may have the same length as that of the configured time domain window 930. The configured time domain window 931 may include an actual time domain window 941 and an actual time domain window 942. The time domain window 941 and the actual time domain window 942 need not include the PUSCH 926.

The PUSCH 920, PUSCH 921, PUSCH 922, PUSCH 923, PUSCH 924, PUSCH 925, PUSCH 926, and PUSCH 927 may be PUSCH repetition transmissions. For example, the number of repetitions corresponding to the PUSCH repetition transmission in FIG. 9 may be 8. For example, the PUSCH repetition transmission in FIG. 9 may correspond to the PUSCH repetition type A. The PUSCH 926 may be dropped. The PUSCH repetition in FIG. 9 may be the repetition transmission of the message 3 PUSCH.

The frequency hopping in FIG. 9 may be the inter-bundle frequency hopping. For example, the bundle may be four slots. For example, the bundle may have the same as that of the configured time domain window 930. For example, the bundle may have the same as that of the configured time domain window 931. The configured time domain window 930 may be configured as a window length by a higher layer parameter. The configured time domain window 931 may be configured as a window length by a higher layer parameter. The bundle may be configured by a higher layer parameter. For example, the bundle may be provided by a higher layer parameter including one value. For example, in FIG. 9, the one value may be 4. For example, in a case that the one value is 8, the bundle may include a slot 910, a slot 911, a slot 912, a slot 913, a slot 914, a slot 915, a slot 916, and a slot 917.

Problem 1 is that the terminal apparatus 1 that does not have a function of performing the DMRS bundling on the message 3 PUSCH needs to perform switching to determine whether to apply the inter-bundle frequency hopping to the PUSCH. For example, Means 1 may be used to solve Problem 1. Problem 2 is that the terminal apparatus 1 having the function of performing the DMRS bundling on the message 3 PUSCH needs to be provided with a higher layer parameter for the configured time domain window from, for example, system information. For example, Means 2 may be used for solving Problem 2. Problem 3 is that the terminal apparatus 1 configured for the inter-bundle frequency hopping can be expected to have improved communication efficiency by ensuring flexibility for the frequency hopping scheme. For example, Means 3 may be used for solving Problem 3.

Means 1, Means 2, and Means 3 may provide a dedicated higher layer parameter used to determine whether the frequency hopping scheme is the inter-bundle frequency hopping. For example, Means 1, Means 2, and Means 3 may provide a dedicated higher layer parameter indicating whether the frequency hopping scheme is inter-bundle frequency hopping. In Means 1, Means 2, and Means 3, a bundle for the inter-bundle frequency hopping may be provided by a higher layer parameter.

Means 1 will be described in paragraphs 0285 to 0295.

In Means 1, the terminal apparatus 1 may determine whether to apply the inter-bundle frequency hopping to the PUSCH based at least on whether the scheduled PUSCH is the message 3 PUSCH. For example, in a case that the PUSCH is the message 3 PUSCH, the inter-slot frequency hopping may be applied to the PUSCH. For example, in a case that the PUSCH is not the message 3 PUSCH, the inter-bundle frequency hopping may be applied to the PUSCH.

In other words, in a case that the PUSCH is not the message 3 PUSCH but the PUSCH is scheduled by the random access response grant, the inter-slot frequency hopping may be applied to the PUSCH.

Note that, in another example, in a case that the PUSCH is not the message 3 PUSCH but the PUSCH is scheduled by the random access response grant, the inter-bundle frequency hopping may be applied to the PUSCH.

For example, in a case that the PUSCH is the message 3 PUSCH and the repetition transmission is applied to the PUSCH, the inter-slot frequency hopping may be applied to the PUSCH. For example, in a case that the PUSCH is a message 3 PUSCH and the repetition transmission is not applied to the PUSCH, the intra-slot frequency hopping may be applied to the PUSCH. For example, in a case that the PUSCH is not the message 3 PUSCH and the repetition transmission is applied to the PUSCH, the inter-bundle frequency hopping may be applied to the PUSCH. For example, in a case that the PUSCH is not the message 3 PUSCH and the repetition is not adapted for the PUSCH, the intra-slot frequency hopping may be applied for the PUSCH.

For example, in a case that the PUSCH is the message 3 PUSCH, the repetition transmission is applied to the PUSCH, and the frequency hopping flag field included in one of the random access response grant and the DCI used for scheduling the PUSCH has a value of 1, the inter-slot frequency hopping may be applied to the PUSCH. For example, in a case that the PUSCH is the message 3 PUSCH, the repetition transmission is applied to the PUSCH, and the frequency hopping flag field included in one of the random access response grant and the DCI used for scheduling the PUSCH has a value of 0, the frequency hopping need not be applied to the PUSCH. For example, in a case that the PUSCH is the message 3 PUSCH, the repetition transmission is not applied to the PUSCH, and the value of the frequency hopping flag field included in one of the random access response grant and the DCI used for scheduling the PUSCH is 1, the intra-slot frequency hopping may be applied to the PUSCH. For example, in a case that the PUSCH is the message 3 PUSCH, the repetition transmission is not applied to the PUSCH, and the frequency hopping flag field included in one of the random access response grant and the DCI used for scheduling the PUSCH has a value of 0, the frequency hopping need not be applied to the PUSCH. For example, in a case that the PUSCH is not the message 3 PUSCH, the repetition transmission is applied to the PUSCH, and the frequency hopping flag field included in the DCI used for scheduling the PUSCH has a value of 1, the inter-bundle frequency hopping may be applied to the PUSCH. For example, in a case that the PUSCH is not the message 3 PUSCH, the repetition transmission is applied to the PUSCH, and the frequency hopping flag field included in the DCI used for scheduling the PUSCH has a value of 0, the frequency hopping may not be applied to the PUSCH. For example, in a case that the PUSCH is not the message 3 PUSCH, the repetition transmission is not applied to the PUSCH, and the frequency hopping flag field included in the DCI used for scheduling the PUSCH has a value of 1, the intra-slot frequency hopping may be applied to the PUSCH. For example, in a case that the PUSCH is not the message 3 PUSCH, the repetition transmission is not applied to the PUSCH, and the frequency hopping flag field included in the DCI used for scheduling the PUSCH has a value of 0, the frequency hopping need not be applied to the PUSCH. The fact that the frequency hopping flag field has a value of 1 may mean that the frequency hopping is applied to the PUSCH. The fact that the frequency hopping flag field has a value of 0 may mean that the frequency hopping is not applied to the PUSCH.

In Means 1 and Means 2, the repetition transmission may be applied to the message 3 PUSCH. For example, the repetition transmission may be applied to the PUSCH scheduled by the DCI with the CRC scrambled by the TC-RNTI. For example, the number of repetitions may be determined based at least on the DCI. For example, the repetition transmission may be applied to the PUSCH scheduled by the random access response grant included in the PDSCH. For example, the number of repetitions may be determined based at least on the random access response grant.

In Means 1 and Means 2, the frequency hopping may be applied to the message 3 PUSCH. For the message 3 PUSCH scheduled by the DCI or the random access response grant, the frequency hopping may be performed based on the DCI or the random access response grant. For example, the inter-slot frequency hopping may be applied to the message 3 PUSCH to which the repetition transmission and the frequency hopping are applied. For example, the intra-slot frequency hopping may be applied to the message 3 PUSCH to which the repetition transmission is not applied and to which the frequency hopping is applied.

In Means 1 and Means 2, one or both of the position of each of the first resource blocks corresponding to the first hop and the second hop and the RBoffset may be provided for the message 3 PUSCH based at least on the common higher layer parameter. In Means 1 and Means 2, one or both of the position of each of the first resource blocks corresponding to the first hop and the second hop and the RBoffset may be given for the message 3 PUSCH without relying on the dedicated higher layer parameter.

In Means 1, one or both of the configured time domain window and the actual time domain window may be applied to the PUSCH scheduled by the DCI with the CRC scrambled by at least one of the C-RNTI, the CS-RNTI, or the MCS-C-RNTI. For example, for the PUSCH, the inter-bundle frequency hopping may be performed. In the frequency hopping for the PUSCH repetition transmission, the number of slots corresponding to the frequency hopping interval may be determined by a higher layer parameter. The higher layer parameter may determine the window length of the configured time domain window.

For example, the number of slots corresponding to the frequency hopping interval may be determined by one higher layer parameter. For example, the one higher layer parameter may be configured for each PUSCH-Config.

For example, the number of slots corresponding to the frequency hopping interval may be determined by one upper layer parameter selected from multiple upper layer parameters. For example, the one upper layer parameter may be determined based at least on one of Element 1 and Element 2 among the multiple upper layer parameters. Element 1 may be the DCI format corresponding to the DCI scheduling the PUSCH to which the frequency hopping is applied. Element 2 may be the time domain resource assignment field included in the DCI scheduling the PUSCH to which the frequency hopping is applied.

In Means 1, one or both of the configured time domain window and the actual time domain window need not be applied to the repetition transmission of the message 3 PUSCH. For example, for the message 3 PUSCH, the inter-bundle frequency hopping need not be performed. In the frequency hopping for repetition transmission of the message 3 PUSCH, the number of slots corresponding to the frequency hopping interval may be 1.

Means 2 will be described in paragraphs 0298 to 0304.

In Means 2, the terminal apparatus 1 may determine which of the first higher layer parameter and the second higher layer parameter is applied to the PUSCH based at least on whether the scheduled PUSCH is the message 3 PUSCH. The first higher layer parameter may be a higher layer parameter for the first configured time domain window. For example, the higher layer parameter for the first configured time domain window may indicate a first window length. The second higher layer parameter may be a higher layer parameter for the second configured time domain window. For example, the higher layer parameter for the second configured time domain window may indicate a second window length. For example, in a case that the PUSCH is the message 3 PUSCH, the first higher layer parameter may be applied to the PUSCH. For example, in a case that the PUSCH is not the message 3 PUSCH, the second higher layer parameter may be applied to the PUSCH. The first higher layer parameter may be a common higher layer parameter. The second higher layer parameter may be a dedicated higher layer parameter.

For example, in a case that the PUSCH is the message 3 PUSCH and the repetition transmission is applied to the PUSCH, the first higher layer parameter may be applied to the PUSCH. For example, in a case that the PUSCH is the message 3 PUSCH and the repetition transmission is not applied to the PUSCH, neither of the first higher layer parameter nor the second higher layer parameter needs to be applied to the PUSCH. For example, in a case that the PUSCH is not the message 3 PUSCH and repetition transmission is applied to the PUSCH, the second higher layer parameter may be applied to the PUSCH. For example, in a case that the PUSCH is not the message 3 PUSCH and the repetition is not applied to the PUSCH, neither of the first higher layer parameter and the second higher layer parameter needs to be applied to the PUSCH.

For example, in a case that the PUSCH is not the message 3 PUSCH but the PUSCH is scheduled by the random access response grant, the inter-bundle frequency hopping may be applied to the PUSCH and the first higher layer parameter may be applied to the PUSCH.

In Means 2, one or both of the configured time domain window and the actual time domain window may be applied to the PUSCH scheduled by the DCI with the CRC scrambled by at least one of the C-RNTI, CS-RNTI, or the MCS-C-RNTI. For example, for the PUSCH, the inter-bundle frequency hopping may be performed. In the frequency hopping for the PUSCH repetition transmission, the number of slots corresponding to a frequency hopping interval may be determined by a first higher layer parameter. The first higher layer parameter may determine the window length of the first configured time domain window.

For example, the first upper layer parameter may be determined based at least on one of Element 1 and Element 2 among the one or multiple upper layer parameters. Element 1 may be the DCI format corresponding to the DCI scheduling the PUSCH to which the frequency hopping is applied. Element 2 may be the time domain resource assignment field included in the DCI scheduling the PUSCH to which the frequency hopping is applied.

In Means 2, one or both of the configured time domain window and the actual time domain window may be applied to the repetition transmission of the message 3 PUSCH. For example, for the message 3 PUSCH, the inter-bundle frequency hopping may be performed. In the frequency hopping for the repetition transmission of the message 3 PUSCH, the number of slots corresponding to the frequency hopping interval may be determined by the second higher layer parameter. The second higher layer parameter may be different from the first higher layer parameter. The second higher layer parameter may determine the window length of the second configured time domain window.

For example, the second upper layer parameter may be determined based at least on one of Element 1 and Element 2 among the one or multiple upper layer parameters. Element 1 may be the DCI format corresponding to the DCI scheduling the PUSCH to which the frequency hopping is applied. Element 2 may be the time domain resource assignment field included in the DCI scheduling the PUSCH to which the frequency hopping is applied.

Means 3 will be described in paragraphs 0306 to 0316.

In Means 3, the frequency hopping may be applied to the PUSCH repetition transmission. For example, the inter-bundle frequency hopping may be applied to the PUSCH repetition transmission. In the frequency hopping for the PUSCH repetition transmission, the number of slots corresponding to the frequency hopping interval may be determined by the first higher layer parameter. In other words, the bundle for the inter-bundle frequency hopping may be determined by the first higher layer parameter. In the frequency hopping for the PUSCH repetition transmission, the frequency hopping scheme may be determined by the second higher layer parameter. The first higher layer parameter may be a dedicated higher layer parameter. The second higher layer parameter may be a dedicated higher layer parameter.

In Means 3, the first higher layer parameter may be different from the second higher layer parameter. For example, the first higher layer parameter may be configured for each PUSCH-Config. For example, the second higher layer parameter may be determined based at least on Element 1 among the one or multiple higher layer parameters in PUSCH-Config. Element 1 may be the DCI format corresponding to the DCI scheduling the PUSCH to which the frequency hopping is applied.

In Means 3, in a case that the first higher layer parameter is configured and the second higher layer parameter indicates the intra-slot frequency hopping, the frequency hopping corresponding to the frequency hopping for the PUSCH may be the intra-slot frequency hopping. In a case that the first higher layer parameter is configured and the second higher layer parameter indicates the inter-slot frequency hopping, the frequency hopping corresponding to the frequency hopping for the PUSCH may be the inter-bundle frequency hopping. In a case that the first higher layer parameter is configured and the second higher layer parameter indicates the inter-bundle frequency hopping, the frequency hopping corresponding to the frequency hopping for the PUSCH may be the inter-bundle frequency hopping.

In Means 3, in a case that the first higher layer parameter is configured and the second higher layer parameter indicates the intra-slot frequency hopping, the frequency hopping interval corresponding to the frequency hopping for the PUSCH may be one slot or less. In a case that the first higher layer parameter is configured and the second higher layer parameter indicates the inter-slot frequency hopping, the frequency hopping interval corresponding to the frequency hopping for the PUSCH may be determined by the first higher layer parameter. In a case that the first higher layer parameter is configured and the second higher layer parameter indicates the inter-bundle frequency hopping, the frequency hopping interval corresponding to the frequency hopping for the PUSCH may be determined by the first higher layer parameter.

In Means 3, in a case that the frequency hopping interval determined by the first higher layer parameter is greater than one slot, the second higher layer parameter need not be expected to indicate the intra-slot frequency hopping. In a case that the number of slots corresponding to the frequency hopping interval for the PUSCH repetition transmission is set to a value larger than 1 by the first higher layer parameter, the terminal apparatus 1 may not perform the intra-slot frequency hopping for the PUSCH repetition transmission.

For example, the first higher layer parameter may be determined based at least on one of element 1 and element 2 among the one or multiple higher layer parameters in the PUSCH-Config. Element 1 may be the DCI format corresponding to the DCI scheduling the PUSCH to which the frequency hopping is applied. Element 2 may be the time domain resource assignment field included in the DCI scheduling the PUSCH to which the frequency hopping is applied.

The first higher layer parameter may determine the window length of the configured time domain window.

In Means 3, the terminal apparatus 1 may determine whether to apply, to the PUSCH, the first higher layer parameter indicating the frequency hopping interval, based at least on the second higher layer parameter indicating the frequency hopping scheme for the scheduled PUSCH. For example, the first higher layer parameter may indicate the number of slots corresponding to the frequency hopping interval for the PUSCH. For example, in a case that the second higher layer parameter indicates intra-slot frequency hopping, the first higher layer parameter need not be applied for PUSCH frequency hopping. For example, in a case that the second higher layer parameter indicates one of the inter-slot frequency hopping and the inter-bundle frequency hopping, the first higher layer parameter may be applied for the PUSCH frequency hopping.

For example, in a case that the second higher layer parameter indicates the intra-slot frequency hopping, the first higher layer parameter need not be applied for the PUSCH frequency hopping, and the first higher layer parameter may be applied for the configured time domain window of the PUSCH. For example, in a case that the second higher layer parameter indicates one of the inter-slot frequency hopping and the inter-bundle frequency hopping, the first higher layer parameter may be applied for the PUSCH frequency hopping, and the first higher layer parameter may be applied for the configured time domain window for the PUSCH.

For example, in a case that the second higher layer parameter indicates the intra-slot frequency hopping and the repetition transmission is applied to the PUSCH, the first higher layer parameter need not be applied for the frequency hopping of the PUSCH repetition, and the first higher layer parameter may be applied for the configured time domain window for the PUSCH repetition transmission. For example, in a case that the second higher layer parameter indicates one of the inter-slot frequency hopping and the inter-bundle frequency hopping and the repetition transmission is applied to the PUSCH, the first higher layer parameter may be applied to the frequency hopping of the PUSCH repetition and the first higher layer parameter may be applied for the configured time domain window for the PUSCH repetition.

For example, in a case that the second higher layer parameter indicates the intra-slot frequency hopping and the repetition transmission is applied to the PUSCH, the first higher layer parameter need not be applied for frequency hopping of the PUSCH repetition, and the window length of the configured time domain window for the PUSCH repetition transmission may be determined based on the first higher layer parameter. For example, in a case that the second higher layer parameter indicates one of inter-slot frequency hopping and inter-bundle frequency hopping and the repetition transmission is applied to the PUSCH, the first higher layer parameter may be applied for the frequency hopping of the PUSCH repetition, and the window length of the configured time domain window for the PUSCH repetition transmission may be determined based on the first higher layer parameter.

Various aspects of apparatuses according to an aspect of the present embodiment will be described below.

(1) In order to accomplish the object described above, an aspect of the present invention is contrived to provide the following means. Specifically, a first aspect of the present invention is a terminal apparatus including a receiver that receives a PDCCH including DCI or receives a PDSCH including a random access response grant, and a transmitter that transmits a PUSCH, in which transmission of the PUSCH is indicated by the DCI or the random access response grant, frequency hopping for the PUSCH is performed based at least on the DCI or the random access response grant, repetition transmission is indicated for the PUSCH, and in a case that transmission of the PUSCH is indicated by the DCI with a CRC scrambled by a TC-RNTI, a frequency hopping interval corresponding to the frequency hopping is one slot, in a case that the transmission of the PUSCH is indicated by the random access response grant, the frequency hopping interval is one slot, and in a case that the transmission of the PUSCH is indicated by the DCI with a CRC scrambled by at least one of a C-RNTI, a CS-RNTI, or an MCS-C-RNTI, the number of slots for the frequency hopping interval is determined by a certain higher layer parameter. One or multiple higher layer parameters may be configured for the number of slots, the certain higher layer parameter may be determined based at least on any of Element 1 and Element 2 among the one or multiple higher layer parameters, the Element 1 may be a DCI format corresponding to the DCI, and the Element 2 may be a time domain resource assignment field included in the DCI. The certain higher layer parameter may determine the window length of the configured time domain window.

(2) A second aspect of the present invention is a terminal apparatus including a receiver that receives a PDCCH including DCI or receives a PDSCH including a random access response grant, and a transmitter that transmits a PUSCH, in which transmission of the PUSCH is indicated by the DCI or the random access response grant, a first higher layer parameter is provided that is used to determine the window length of a first configured time domain window and a second higher layer parameter is provided that is used to determine the window length of a second configured time domain window, repetition transmission is applied to the PUSCH, in a case that the transmission of the PUSCH is indicated by the DCI with a CRC scrambled by a TC-RNTI, the window length of the first configured time domain window is applied for the PUSCH, in a case that the transmission of the PUSCH is indicated by the random access response grant, the window length of the first configured time domain window is applied for the PUSCH, and in a case that the transmission of the PUSCH is indicated by the DCI with a CRC scrambled by at least one of a C-RNTI, a CS-RNTI, or an MCS-C-RNTI, the window length of the second configured time domain window is applied for the PUSCH. The first higher layer parameter may be a common higher layer parameter, and the second higher layer parameter may be a dedicated higher layer parameter.

(3) A third aspect of the present invention is a terminal apparatus including a receiver that receives a PDCCH including DCI indicating transmission of a PUSCH, and a transmitter that transmits the PUSCH, in which frequency hopping for the PUSCH is performed based at least on the DCI, the number of slots for a frequency hopping interval corresponding to the frequency hopping is determined by a first higher layer parameter, a frequency hopping scheme corresponding to the frequency hopping is configured by a second higher layer parameter different from the first higher layer parameter, in a case that the second higher layer parameter indicates intra-slot frequency hopping, the frequency hopping interval is one slot or less, and in a case that the second higher layer parameter indicates one of inter-slot frequency hopping and inter-bundle frequency hopping, the frequency hopping interval is the number of slots. One or more higher layer parameters may be configured for the number of slots, and the first higher layer parameter may be determined based at least on one of Element 1 and Element 2 among the one or multiple higher layer parameters, the Element 1 may be a DCI format corresponding to the DCI, and the Element 2 may be a time domain resource assignment field included in the DCI. In a case that the second higher layer parameter indicates the intra-slot frequency hopping, a window length of the configured time domain window for the PUSCH may be determined based on the first higher layer parameter, and in a case that the second higher layer parameter indicates one of the inter-slot frequency hopping and the inter-bundle frequency hopping, the window length of the configured time domain window for the PUSCH may be determined based on the first higher layer parameter.

(4) A fourth aspect of the present invention is a terminal apparatus including a receiver that receives a PDCCH including DCI indicating transmission of a PUSCH, and a transmitter that transmits the PUSCH, in which frequency hopping for the PUSCH is performed based at least on the DCI, the number of slots for a frequency hopping interval corresponding to the frequency hopping is determined by a first higher layer parameter, a frequency hopping scheme corresponding to the frequency hopping is configured by a second higher layer parameter different from the first higher layer parameter, and based on the fact that the number of slots for the frequency hopping interval is greater than one, the second higher layer parameter is not expected to indicate the intra-slot frequency hopping. One or more higher layer parameters may be configured for the number of slots, and the first higher layer parameter may be determined based at least on one of Element 1 and Element 2 among the one or multiple higher layer parameters, the Element 1 may be a DCI format corresponding to the DCI, and the Element 2 may be a time domain resource assignment field included in the DCI. A window length of the configured time domain window for the PUSCH may be determined based on the first higher layer parameter.

(5) A fifth aspect of the present invention is a base station apparatus including a transmitter that transmits a PDCCH including DCI or transmits a PDSCH including a random access response grant, and a receiver that receives a PUSCH, in which transmission of the PUSCH is indicated by the DCI or the random access response grant, frequency hopping for the PUSCH is performed based at least on the DCI or the random access response grant, in a case that the transmission of the PUSCH is indicated by the DCI with a CRC scrambled by a TC-RNTI, and that repetition transmission is applied to the transmission of the PUSCH, a frequency hopping interval corresponding to the frequency hopping is one slot, in a case that the transmission of the PUSCH is indicated by the random access response grant, and that the repetition transmission is applied to the transmission of the PUSCH, the frequency hopping interval is one slot, and in a case that the DCI includes a CRC scrambled by at least one of a C-RNTI, a CS-RNTI, or an MCS-C-RNTI, and that the repetition transmission is applied to the transmission of the PUSCH, the number of slots for the frequency hopping interval is determined by a certain higher layer parameter. One or multiple higher layer parameters may be configured for the number of slots, the certain higher layer parameter may be determined based at least on any of Element 1 and Element 2 among the one or multiple higher layer parameters, the Element 1 may be a DCI format corresponding to the DCI, and the Element 2 may be a time domain resource assignment field included in the DCI. The certain higher layer parameter may determine the window length of the configured time domain window.

(6) A sixth aspect of the present invention is a base station apparatus including a transmitter that transmits a PDCCH including DCI or transmits a PDSCH including a random access response grant, and a receiver that receives a PUSCH, in which transmission of the PUSCH is indicated by the DCI or the random access response grant, a first higher layer parameter is provided that is used to determine a window length of a first configured time domain window and a second higher layer parameter is provided that is used to determine a window length of a second configured time domain window, repetition transmission is applied to the PUSCH, in a case that the DCI includes a CRC scrambled by a TC-RNTI, and that repetition transmission is applied to the transmission of the PUSCH, the window length of the first configured time domain window is applied for the PUSCH, in a case that the transmission of the PUSCH is indicated by the random access response grant, and that the repetition transmission is applied to the transmission of the PUSCH, the window length of the first configured time domain window is applied for the PUSCH, and in a case that the DCI includes a CRC scrambled by at least one of a C-RNTI, a CS-RNTI, or an MCS-C-RNTI, the window length of the second configured time domain window is applied for the PUSCH. The first higher layer parameter may be a common higher layer parameter, and the second higher layer parameter may be a dedicated higher layer parameter.

(7) A seventh aspect of the present invention is a base station apparatus including a receiver that transmits a PDCCH including DCI indicating transmission of a PUSCH, and a receiver that receives the PUSCH, in which frequency hopping for the PUSCH is performed based at least on the DCI, the number of slots for a frequency hopping interval corresponding to the frequency hopping is determined by a first higher layer parameter, a frequency hopping scheme corresponding to the frequency hopping is configured by a second higher layer parameter different from the first higher layer parameter, in a case that the second higher layer parameter indicates intra-slot frequency hopping, the frequency hopping interval is one slot or less, and in a case that the second higher layer parameter indicates one of inter-slot frequency hopping and inter-bundle frequency hopping, the frequency hopping interval is the number of slots. One or more higher layer parameters may be configured for the number of slots, and the first higher layer parameter may be determined based at least on one of Element 1 and Element 2 among the one or multiple higher layer parameters, the Element 1 may be a DCI format corresponding to the DCI, and the Element 2 may be a time domain resource assignment field included in the DCI. In a case that the second higher layer parameter indicates the intra-slot frequency hopping, a window length of the configured time domain window for the PUSCH may be determined based on the first higher layer parameter, and in a case that the second higher layer parameter indicates one of the inter-slot frequency hopping and the inter-bundle frequency hopping, the window length of the configured time domain window for the PUSCH may be determined based on the first higher layer parameter.

(8) An eighth aspect of the present invention is a base station apparatus including a transmitter that transmits a PDCCH including DCI indicating transmission of a PUSCH, and a receiver that receives the PUSCH, in which frequency hopping for the PUSCH is performed based at least on the DCI, the number of slots for a frequency hopping interval corresponding to the frequency hopping is determined by a first higher layer parameter, a frequency hopping scheme corresponding to the frequency hopping is configured by a second higher layer parameter different from the first higher layer parameter, and based on the fact that the number of slots for the frequency hopping interval is greater than one, the second higher layer parameter is not expected to indicate intra-slot frequency hopping. One or more higher layer parameters may be configured for the number of slots, and the first higher layer parameter may be determined based at least on one of Element 1 and Element 2 among the one or multiple higher layer parameters, the Element 1 may be a DCI format corresponding to the DCI, and the Element 2 may be a time domain resource assignment field included in the DCI. A window length of the configured time domain window for the PUSCH may be determined based on the first higher layer parameter.

A program running on the base station apparatus 3 and the terminal apparatus 1 according to an aspect of the present invention may be a program (a program that causes a computer to function) that controls a Central Processing Unit (CPU) and the like so as to implement the functions of the above-described embodiment according to an aspect of the present invention. The information handled in these apparatuses is temporarily loaded into a Random Access Memory (RAM) while being processed, is then stored in a Hard Disk Drive (HDD) and various types of Read Only Memory (ROM) such as a Flash ROM, and is read, modified, and written by the CPU, as necessary.

Note that the terminal apparatus 1 and the base station apparatus 3 according to the above-described embodiment may be partially implemented by a computer. In that case, this configuration may be implemented by recording a program for implementing such control functions on a computer-readable recording medium and causing a computer system to read the program recorded on the recording medium for execution.

Note that it is assumed that the “computer system” mentioned here refers to a computer system built into the terminal apparatus 1 or the base station apparatus 3, and the computer system includes an OS and hardware components such as peripheral devices. A “computer-readable recording medium” refers to a portable medium such as a flexible disk, a magneto-optical disk, a ROM, and a CD-ROM, and a storage apparatus such as a hard disk built into the computer system.

Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a certain period of time, such as a volatile memory included in the computer system functioning as a server or a client in such a case. The above-described program may be one for implementing a part of the above-described functions, and also may be one capable of implementing the above-described functions in combination with a program already recorded in a computer system.

Furthermore, the base station apparatus 3 according to the aforementioned embodiment may be implemented as an aggregation (apparatus group) including multiple apparatuses. Each of the apparatuses included in such an apparatus group may include a part or all of each function or each functional block of the base station apparatus 3 according to the aforementioned embodiment. As the apparatus group, it is only necessary to have all of functions or functional blocks of the base station apparatus 3. Moreover, the terminal apparatus 1 according to the aforementioned embodiment can also communicate with the base station apparatus as the aggregation.

Also, the base station apparatus 3 according to the aforementioned embodiment may be an Evolved Universal Terrestrial Radio Access Network (EUTRAN) and/or a NextGen RAN (NG-RAN or NR RAN). Moreover, the base station apparatus 3 according to the aforementioned embodiment may have a part or all of the functions of a higher node for an eNodeB and/or a gNB.

Also, a part or all portions of each of the terminal apparatus 1 and the base station apparatus 3 according to the aforementioned embodiment may be implemented as an LSI, which is typically an integrated circuit, or may be implemented as a chip set. The functional blocks of each of the terminal apparatus 1 and the base station apparatus 3 may be individually implemented as a chip, or a part or all of the functional blocks may be integrated into a chip. Furthermore, a circuit integration technique is not limited to the LSI and may be implemented with a dedicated circuit or a general-purpose processor. Moreover, in a case that a circuit integration technology that substitutes an LSI appears with the advance of the semiconductor technology, it is also possible to use an integrated circuit based on the technology.

In addition, although the aforementioned embodiments have described the terminal apparatus as an example of a communication apparatus, the present invention is not limited to such a terminal apparatus, and is also applicable to a terminal apparatus or a communication apparatus that is a stationary type or a non-movable type electronic apparatus installed indoors or outdoors, for example, such as an AV device, a kitchen device, a cleaning or washing machine, an air-conditioning device, office equipment, a vending machine, and other household appliances.

Although, the embodiments of the present invention have been described in detail above referring to the drawings, the specific configuration is not limited to the embodiments and includes, for example, design changes within the scope that does not depart from the gist of the present invention. For an aspect of the present invention, various modifications are possible within the scope of the claims, and embodiments that are made by suitably combining technical means disclosed according to the different embodiments are also included in the technical scope of the present invention. A configuration in which elements described in the respective embodiments and having mutually the similar effects, are substituted for one another is also included.

### INDUSTRIAL APPLICABILITY

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

1 (1A, 1B, 1C) Terminal apparatus
3 Base station apparatus
10, 30 Radio transmission and/or reception circuitry
10a, 30a Radio transmission circuitry
10b, 30b Radio reception circuitry
11, 31 Antenna circuitry
12, 32 RF circuitry
13, 33 Baseband circuitry
14, 34 Higher layer processing circuitry
15, 35 Medium access control layer processing circuitry
16, 36 Radio resource control layer processing circuitry
91, 92, 93, 94 Search space set
300 Component carrier
301 Primary cell
302, 303 Secondary cell
700 Set of resource elements for PSS
710, 711, 712, 713 Set of resource elements for PBCH and DMRS for PBCH
720 Set of resource elements for SSS
3000 Point
3001, 3002 Resource grid
3003, 3004 BWP
3011, 3012, 3013, 3014 Offset
3100, 3200 Common resource block set
900, 901 Resource block
910, 911, 912, 913, 914, 915, 916, 917 Slot
920, 921, 922, 923, 924, 925, 926, 927 PUSCH
930, 931 Configured time domain window
940, 941 Actual time domain window

1. A terminal apparatus comprising:
a receiver configured to receive a PDCCH to which DCI scheduling a PUSCH is mapped; and
a transmitter configured to transmit the PUSCH, wherein
frequency hopping for the PUSCH is performed based at least on the DCI,
DMRS bundling for the PUSCH is performed,
a first upper layer parameter and a second upper layer parameter are configured,
in a case that the second upper layer parameter indicates intra-slot frequency hopping, a frequency hopping interval corresponding to the frequency hopping is one slot or less, and
in a case that the second upper layer parameter indicates inter-slot frequency hopping, the frequency hopping interval is determined by the first upper layer parameter.

2. A base station apparatus comprising:
a transmitter configured to transmit a PDCCH to which DCI scheduling a PUSCH is mapped; and
a receiver configured to receive the PUSCH, wherein
frequency hopping for the PUSCH is performed based at least on the DCI,
DMRS bundling for the PUSCH is performed,
a first upper layer parameter and a second upper layer parameter are configured,
in a case that the second upper layer parameter indicates intra-slot frequency hopping, a frequency hopping interval corresponding to the frequency hopping is one slot or less, and
in a case that the second upper layer parameter indicates inter-slot frequency hopping, the frequency hopping interval is determined by the first upper layer parameter.

3. A communication method used in a terminal apparatus, the communication method comprising the steps of:
receiving a PDCCH to which DCI scheduling a PUSCH is mapped; and
transmitting the PUSCH, wherein
frequency hopping for the PUSCH is performed based at least on the DCI,
DMRS bundling for the PUSCH is performed,
a first upper layer parameter and a second upper layer parameter are configured,
in a case that the second upper layer parameter indicates intra-slot frequency hopping, a frequency hopping interval corresponding to the frequency hopping is one slot or less, and
in a case that the second upper layer parameter indicates inter-slot frequency hopping, the frequency hopping interval is determined by the first upper layer parameter.
